(19) United States
(12) Patent Application Publication
(10) Pub. No.: US 2016/0109751 A1
(43) Pub. Date: Apr. 21, 2016

(54) Color Filter, Liquid Crystal Display Apparatus, and Method of Manufacturing Color Filter

(71) Applicant: SAKAI DISPLAY PRODUCTS CORPORATION, Sakai-shi, Osaka (JP)

(72) Inventor: Hidetoshi Nakagawa, Sakai-shi, Osaka (JP)

(21) Appl. No.: 14/888,069

(22) PCT Filed: Jul. 8, 2014
(86) PCT No.: PCT/JP2014/068208

§ 371 Date: Oct. 29, 2015

(30) Foreign Application Priority Data
Jul. 17, 2013 (JP) 2013-148779

(51) Int. Cl. G02F 1/1335; G02B 5/20

(52) U.S. Cl. CPC G02F 1/133514; G02F 1/133512; G02B 5/201

(57) ABSTRACT

Provided are a color filter capable of improving an aperture ratio of a BM, a liquid crystal display apparatus, and a method of manufacturing the color filter. For an R layer disposed in an opening, a right exposure part and a left exposure part of a G layer disposed in an opening adjacent to a right side of the opening are patterned by exposing using an alignment mark. Briefly, portions of the RGB layers facing each other in a horizontal direction, which are respectively to be disposed in two openings adjacent to each other in the horizontal direction, may be patterned by exposing using the same alignment mark. As a result, unnecessarily close arrangement or separated arrangement of the RGB layers caused by referring to the different alignment marks does not occur. Consequently, there is no need to increase a BM between the RGB layers in the horizontal direction. Therefore, an aperture ratio of the BM is improved.

### CROSS-REFERENCE TO RELATED APPLICATIONS

This application is the national phase under 35 U. S. C. §371 of PCT International Application No. PCT/JP2014/068208 which has an International filing date of Jul. 8, 2014 and designated the United States of America.

### FIELD

The present invention relates to a color filter, a liquid crystal display apparatus, and a method of manufacturing the color filter.

### BACKGROUND

A liquid crystal display apparatus includes, for example, a color filter on which colored layers of RGB three primary colors are patterned, a TFT substrate for driving liquid crystal, a liquid crystal layer, a set of polarizing plates, a backlight unit and the like. Hereinafter, the colored layers of red, green, and blue are referred to as an R layer, a G layer, and a B layer, respectively. In addition, when the R layer, the G layer and the B layer cannot be distinguished, the colored layer is referred to as an RGB layer.

The color filter includes a transparent glass substrate, and a black matrix formed on one surface of the glass substrate (see Japanese Patent Application Laid-open No. 2010-134483). The black matrix (hereinafter, referred to as a BM) is a light shielding layer provided with a plurality of openings, each of which has a rectangular shape. Hereinafter, a case in which a plurality of openings are arranged in parallel in a horizontal direction and a vertical direction will be described.

Three openings adjacent to each other in the horizontal direction correspond to one pixel of a color image. The R layer is disposed in an opening on a left side, the G layer is disposed in an opening of a horizontal central part, and the B layer is disposed in an opening on a right side. Each RGB layer is formed in a rectangular shape to close the opening, and to be partially overlapped with peripheral edge part (that is, the BM) of the opening.

The liquid crystal layer is sealed between the color filter and the TFT substrate. One polarizing plate is disposed on a front side of the color filter, and the backlight unit is disposed on a back side of the TFT substrate on the other polarizing plate.

Light emitted from the backlight unit of the liquid crystal display apparatus is transmitted through the polarizing plate on the back side, the TFT substrate, and the liquid crystal layer in this order, and is made incident on the color filter. The light made incident on the color filter is transmitted through any one of the R layer, the G layer, and the B layer, to thus be colored in any one of the RGB three primary colors. The colored light is emitted from the color filter, and then is blocked by the polarizing plate on the front side or is transmitted through the polarizing plate. From the above result, the color image is displayed on the liquid crystal display apparatus.

When manufacturing the color filter, first the BM is patterned on one surface of the glass substrate. At this time, a plurality of alignment marks are provided thereon. The RGB layers are patterned by referring to these alignment marks.

Due to an arrangement error of the alignment marks during forming the BM, a read error of the alignment marks during forming the RGB layer, and the like, the respective RGB layers may be formed in a state of occurring a positional shift with respect to the openings.

In particular, in the two openings adjacent to each other in the horizontal direction, when referring to the alignment marks different from each other during forming the B layer with respect to the opening on the left side, and during forming the R layer with respect to the opening on the right side, the B layer of the opening on the left side may occur the positional shift to a right side with respect to the opening, and the R layer of the opening on the right side may occur the positional shift to the left side with respect to the opening. Briefly, the B layer and the R layer are unnecessarily arranged close to each other. At this time, in the respective B and R layers, width of a portion overlapped with the BM between the two openings (hereinafter, referred to as a vertical BM) becomes larger. Reversely, if the B layer occurs the positional shift to the left side, and the R layer occurs the positional shift to the right side, the B layer and the R layer are unnecessarily arranged apart from each other. At this time, in the respective B and R layers, the portions overlapped with the vertical BM are small.

Conventionally, a color filter, in which a length in the horizontal direction (hereinafter, referred to as a horizontal width) of the overlapped portion with respect to the BM of the RGB layer is deliberately varied, and furthermore, a variation degree in the horizontal width of the overlapped portion is uniform across the whole of a display region, has been disclosed (see International Publication No. 2010/125825).

In the case of a liquid crystal display apparatus including the color filter described in International Publication No. 2010/125825, since display unevenness caused by a variation in the horizontal width of the overlapped portion is difficult to see, it is possible to improve the image quality of the color image displayed on the liquid crystal display apparatus.

### SUMMARY

If the RGB layers are unnecessarily arranged close to or apart from each other, a part of the openings may not be covered with the RGB layers. The horizontal width of the vertical BM has been previously provided to be longer, so as not to occur such a problem.

In this regard, unnecessarily close arrangement or separated arrangement of the RGB layers caused by referring to the different alignment marks is a phenomenon occurring at a part of the color filter. However, when increasing only the horizontal width of the vertical BM according to the part of the BM, a difference in the horizontal width of the vertical BMs may lead to the display unevenness. Therefore, there is no choice but to increase the horizontal width of the vertical BM according to the whole of the BM.

From the above result, a problem that the BM has a low aperture ratio in a range corresponding to the display region of the liquid crystal display apparatus may occur.

Japanese Patent Application Laid-open No. 2010-134483 and International Publication No. 2010/125825 do not describe technical matters for improving the aperture ratio of the BM.

In consideration of the above-mentioned circumstances, it is a major object of the present invention to provide a color filter capable of improving an aperture ratio of a BM, a liquid crystal display apparatus, and a method of manufacturing the color filter.

According to one aspect of the present invention, there is provided a color filter including: a transparent substrate; a light shielding layer which is formed on one surface of the transparent substrate, and includes a plurality of openings arranged in parallel in one direction thereof; and a colored layer which is disposed in each opening to close the opening, and a part of which is overlapped with the light shielding layer, wherein the colored layers respectively disposed in the at least two openings have a colored convex part at a central part in the one direction.

In the color filter according to the present invention, the light shielding layer has a light shielding convex part at a position corresponding to the central part in the one direction.

In the color filter according to the present invention, the openings are arranged in parallel in the one direction and the other direction crossing to the one direction, and a length between the openings adjacent to each other in the one direction is longer than a length between the openings adjacent to each other in the other direction.

In the color filter according to the present invention, the openings are arranged in parallel in the one direction and the other direction crossing to the one direction, the colored convex part is formed so as to have any one of: at the central part of the colored layer in the one direction thereof, a straight line shape reaching both end parts in the other direction; at the central part of the colored layer in the one direction thereof, a line shape along a peripheral edge part of the opening reaching both end parts in the other direction; and at the central part of the colored layer in the one direction thereof, a bent line shape reaching a central part in the other direction from one end part in the other direction, and reaching the one end part in the other direction from the central part.

According to another aspect of the present invention, there is provided a liquid crystal display apparatus including: a liquid crystal layer formed using liquid crystal; and a color filter configured to color light transmitted through the liquid crystal layer, wherein the color filter is the color filter according to the present invention.

The liquid crystal display apparatus according to the present invention, includes a blockage part configured to block light from being incident on the liquid crystal layer, or block light transmitted through the liquid crystal layer from being emitted, wherein an arrangement position of the colored convex part of the color filter corresponds to an arrangement position of the blockage part.

According to another aspect of the present invention, there is provided a method of manufacturing a color filter which includes: a light shielding layer forming process of patterning a light shielding layer provided with a plurality of openings arranged in one direction thereof and a plurality of alignment marks on one surface of a transparent substrate, and a colored layer forming process of patterning a colored layer which is disposed in each opening to close the opening, and is partially overlapped with the light shielding layer, wherein, in the colored layer forming process, portions of the colored layer facing each other in the one direction thereof, which are to be respectively disposed in the two openings adjacent to each other in the one direction, are patterned by exposing using the same alignment mark to manufacture the color filter according to the present invention, the method characterized in that: the colored layer forming process includes: a process of laminating a first colored material layer to form a colored layer of a first color on the transparent substrate bared through the light shielding layer and the opening; a first exposing process of performing a first exposure on the first colored material layer corresponding to a part of a first colored layer including one side in the one direction thereof, which is to be disposed in a first opening, using one alignment mark; a second exposing process of performing a second exposure on the first colored material layer corresponding to the residual part of the first colored layer, and again performing the exposure on the first colored material layer which is located at a central part of the portion to form the first colored layer in the one direction thereof, and on which the first exposure was performed; a process of, after the first exposing process and the second exposing process end, forming the first colored layer; a process of laminating a second colored material layer to form a colored layer of a second color different from the first color on the transparent substrate bared through the light shielding layer and the opening; a third exposing process of performing a third exposure on the second colored material layer corresponding to a part of a second colored layer including the other side in the one direction thereof, which is to be disposed in a second opening adjacent to the one side in the one direction in the first opening, using the one alignment mark; a fourth exposing process of performing a fourth exposure on the second colored material layer corresponding to the residual part of the second colored layer, and again performing the exposure on the second colored material layer which is located at the central part of the portion to form the second colored layer in the one direction thereof, and on which the third exposure was performed; and a process of, after the third exposing process and the fourth exposing process end, forming the second colored layer.

In the method of manufacturing a color filter according to the present invention, the light shielding layer forming process includes: a process of laminating a light shielding material layer to form the light shielding layer on the one surface of the transparent substrate; a fifth exposing process of performing a fifth exposure on the light shielding material layer corresponding to a part of the light shielding layer in the one direction thereof; a sixth exposing process of performing a sixth exposure on the light shielding material layer corresponding to the other part adjacent to the part of the light shielding layer in the one direction thereof, and again performing the exposure at a position corresponding to the central part of the portion to form the opening in the one direction thereof, among the light shielding material layer on which the fifth exposure was performed; and a process of, after the fifth exposing process and the sixth exposing process end, forming the light shielding layer.

In the present invention, the liquid crystal display apparatus includes the color filter according to the present invention. The color filter according to the present invention is manufactured, for example, by the method of manufacturing a color filter according to the present invention.

An RGB layer formed by performing the first exposing process and the second exposing process (or the third exposing process and the fourth exposing process) has a colored convex part at the horizontal central part. The reason is that, in the patterning, it would be difficult for a twice exposed colored material layer to be removed compared to an once exposed colored material layer. Accordingly, the remaining portion without being removed becomes a convex step part when viewed from a removed portion. This part is the colored convex part. Since a protruding amount of the colored convex part is sufficiently smaller than a thickness of the RGB layer, an adverse effect applied to the display of the color image is minor by the colored convex part.

A portion formed by the first exposing process in the RGB layer disposed in the first opening (hereinafter, referred to as a first exposure part) and a portion formed by the third exposing process in the RGB layer disposed in the second opening (hereinafter, referred to as a third exposure part) face each other in the horizontal direction. In addition, both of the first exposure part and the third exposure part are formed by exposing using one alignment mark. Briefly, the first exposure part and the third exposure part do not occur the unnecessarily close arrangement or separated arrangement caused by referring to the different alignment marks.

Meanwhile, both of a second exposure part formed by the second exposing process in the RGB layer disposed in the first opening and a fourth exposure part formed by the fourth exposing process in the RGB layer disposed in the second opening are formed by exposing using the other alignment mark.

The RGB layer to be disposed in the opening other than the first and second openings may be patterned by twice exposing using two alignment marks, similar to the RGB layer to be disposed in the first and second openings, or may be patterned by once exposing using one alignment mark, similar to the conventional RGB layer. By properly using these methods, the portions of the RGB layer facing each other in the horizontal direction thereof, which are to be respectively disposed in two openings adjacent to each other in the horizontal direction, may be patterned by exposing using the same alignment mark. As a result, the unnecessarily close arrangement or separated arrangement caused by referring to the different alignment marks does not occur.

From the above result, there is no need to increase a horizontal width of a vertical BM. Therefore, an aperture ratio of the BM is improved.

In the present invention, for the BM, the twice exposed portion by the fifth exposing process and the sixth exposing process is, so to speak, a joint between one part and the other part of the BM in the horizontal direction thereof. The joint is located at a portion independent of the vertical BM.

Therefore, in the light shielding material layer, even when a portion exposed by the sixth exposing process occurs a relative positional shift in the horizontal direction with respect to a portion exposed by the fifth exposing process, it does not adversely affect the horizontal width of the vertical BM. In other words, it is possible to constantly maintain the horizontal width of the vertical BM.

In the present invention, for example, the length between the openings adjacent to each other in the horizontal direction is equal to the horizontal length according to the BM between two openings adjacent to each other in the horizontal direction (that is, the horizontal width of the vertical BM). The horizontal width of the vertical BM is longer than the length of the openings adjacent to each other in the vertical direction, that is, the horizontal length according to the BM between the two openings adjacent to each other in the vertical direction (hereinafter, referred to as a horizontal BM).

Generally, when compared to further shortening the shorter ones, it is easy to shorten the longer ones. Briefly, by shortening a portion which is relatively liable to be shortened in the BM, it is possible to efficiently improve the aperture ratio thereof.

In the present invention, the shape of the colored convex part may be a straight line shape or a bent line shape, and either may correspond to the shape of the opening, or may be independent of the shape of the opening. Briefly, freedom of design for the shape of the portion exposed by the first exposing process (or the third exposing process), and the shape of the portion exposed by the second exposing process (or the fourth exposing process) is high.

In the present invention, the arrangement position of the colored convex part corresponds to the arrangement position of the blockage part.

It is slightly difficult for light to be transmitted through the portion having the colored convex part of the RGB layer, compared to the portion which does not have the colored convex part of the RGB layer. However, because the blockage part blocks the light from being emitted to an outside of the liquid crystal display apparatus, even if the transparency of the portion having the colored convex part of the RGB layer is lower, there is no particular problem. Therefore, an adverse effect applied to the display of the color image by the colored convex portion may be disregarded.

In the case of using the color filter, the liquid crystal display apparatus, and the method of manufacturing a color filter of the present invention, for example, the RGB layers adjacent to each other via the vertical BM do not occur the unnecessarily close arrangement or separated arrangement caused by referring to the different alignment marks. Therefore, it is possible to shorten the horizontal width of the vertical BM more than the conventional color filter. As a result, it is possible to improve the aperture ratio of the BM.

The liquid crystal display apparatus including the color filter with high aperture ratio of the BM may improve usage efficiency of light when displaying the color image.

The above and further objects and features will more fully be apparent from the following detailed description with accompanying drawings.

### BRIEF DESCRIPTION OF THE DRAWINGS

FIG. 1 is a cross-sectional view schematically illustrating a configuration of a liquid crystal display apparatus according to Embodiment 1 of the present invention.

FIG. 2 is a front view schematically illustrating a configuration of a color filter according to Embodiment 1 of the present invention.

FIG. 3 is a front view schematically illustrating an arrangement of RGB layers included in the color filter.

FIG. 4 is a front view schematically illustrating a configuration of an exposure mask for patterning a BM.

FIG. 5A is a schematic view for describing a forming procedure of the BM.

FIG. 5B is a schematic view for describing the forming procedure of the BM.

FIG. 5C is a schematic view for describing the forming procedure of the BM.

FIG. 6A is a schematic view for describing the forming procedure of the BM.

FIG. 6B is a schematic view for describing the forming procedure of the BM.

FIG. 7 is a front view schematically illustrating a configuration of an exposure mask for pattering a RGB layer.

FIG. 8 is a front view schematically illustrating mask patterns provided in a left side mask part and a central mask part of an exposure mask for pattering an R layer.

FIG. 9 is a front view schematically illustrating mask patterns provided in a left side mask part and a central mask part of an exposure mask for pattering a G layer.

FIG. 10 is a front view schematically illustrating mask patterns provided in a left side mask part and a central mask part of an exposure mask for pattering a B layer.

FIG. 11 is a schematic cross-sectional view for describing a forming procedure of the R layer.

FIG. 12 is a schematic cross-sectional view for describing the forming procedure of the R layer.

FIG. 13 is a schematic cross-sectional view for describing the forming procedure of the R layer.

FIG. 14 is a schematic cross-sectional view for describing a forming procedure of the G layer.

FIG. 15 is a schematic cross-sectional view for describing the forming procedure of the G layer.

FIG. 16 is a schematic cross-sectional view for describing the forming procedure of the G layer.

FIG. 17 is a schematic cross-sectional view for describing a forming procedure of the B layer.

FIG. 18 is a schematic cross-sectional view for describing the forming procedure of the B layer.

FIG. 19 is a schematic cross-sectional view for describing the forming procedure of the B layer.

FIG. 20 is a front view schematically illustrating an arrangement of the RGB layers included in a conventional color filter.

FIG. 21 is a front view schematically illustrating a configuration of a color filter according to Embodiment 2 of the present invention.

FIG. 22 is a front view schematically illustrating a configuration of an exposure mask for patterning a BM included in a color filter according to Embodiment 3 of the present invention.

FIG. 23A is a schematic view for describing a forming procedure of the BM.

FIG. 23B is a schematic view for describing the forming procedure of the BM.

FIG. 23C is a schematic view for describing the forming procedure of the BM.

FIG. 24A is a schematic view for describing the forming procedure of the BM.

FIG. 24B is a schematic view for describing the forming procedure of the BM.

FIG. 25 is a front view schematically illustrating a configuration of an exposure mask (a left side mask part and a right side mask part) for patterning a BM included in a color filter according to Embodiment 4 of the present invention.

FIG. 26 is a front view schematically illustrating the configuration of the exposure mask (a central mask part) for patterning the BM included in the color filter according to Embodiment 4 of the present invention.

FIG. 27 is a schematic view for describing a forming procedure of the BM.

FIG. 28 is a front view schematically illustrating a configuration of a color filter according to Embodiment 5 of the present invention.

FIG. 29 is a front view schematically illustrating a configuration of RGB layers (bent line-shaped colored convex parts) of a color filter according to Embodiment 6 of the present invention.

FIG. 30 is a front view schematically illustrating a configuration of the RGB layers (straight line-shaped colored convex parts) of the color filter according to Embodiment 6 of the present invention.

FIG. 31 is a front view schematically illustrating a configuration of a color filter according to Embodiment 7 of the present invention.

FIG. 32 is a front view schematically illustrating a configuration of a color filter according to Embodiment 8 of the present invention.

FIG. 33 is a front view schematically illustrating a configuration of a color filter according to Embodiment 9 of the present invention.

FIG. 34 is a front view schematically illustrating a configuration of a color filter according to Embodiment 10 of the present invention.

FIG. 35 is a front view schematically illustrating a configuration of a color filter according to Embodiment 11 of the present invention.

FIG. 36 is a front view schematically illustrating a configuration of a color filter according to Embodiment 12 of the present invention.

### DETAILED DESCRIPTION

Hereinafter, the present invention will be described in detail with reference to the accompanying drawings illustrating embodiments thereof. In the following description, upper and lower, front and rear, and left and right illustrated by arrows in drawings are used. In addition, a front side and a rear side are also referred to as a front side and a back side. Further, a vertical direction and a horizontal direction are also referred to as a longitudinal direction and a lateral direction.

### Embodiment 1

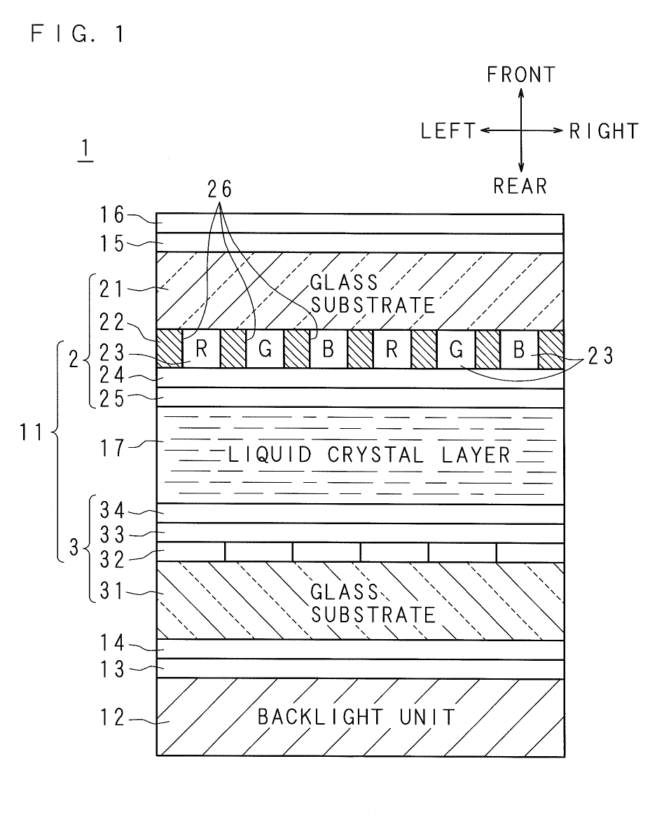

FIG. 1 is a cross-sectional view schematically illustrating a configuration of a liquid crystal display apparatus 1 according to Embodiment 1 of the present invention.

The liquid crystal display apparatus 1 is formed, for example, as a television receiver, a display or the like.

The liquid crystal display apparatus 1 has a structure and a manufacturing procedure of a color filter 2 to be described below different from the structure and the manufacturing procedure of a conventional color filter. That is, the structure and the manufacturing procedure of the liquid crystal display apparatus 1 are the same as the structure and the manufacturing procedure of the conventional color filter except the color filter 2. In addition, a display procedure of a color image in the liquid crystal display apparatus 1 is the same as the display procedure of the color image in the conventional liquid crystal display apparatus.

First, a configuration of the liquid crystal display apparatus 1 will be described.

The liquid crystal display apparatus 1 includes an LCD module 11, a backlight unit 12, a diffusion plate 13, polarizing plates 14 and 15, and a protective glass 16.

The backlight unit 12 is a direct type or an edge light type lighting device, and is disposed on a back side of the liquid crystal display apparatus 1.

The diffusion plate 13, the polarizing plate 14, the LCD module 11, the polarizing plate 15, and the protective glass 16 are disposed on a front side of the backlight unit 12 from the back side to the front side in this order. The polarizing plates 14 and 15 allow linearly polarized lights orthogonal to each other to be transmitted therethrough.

The LCD module 11 includes a liquid crystal layer 17, the color filter 2, and a TFT substrate 3.

The TFT substrate 3 is disposed on the back side of the LCD module 11. The TFT substrate 3 includes a thin-film transistor part 32, a transparent electrode part 33, and an alignment film 34, which are disposed on the front of a glass substrate 31 from the back side to the front side in this order.

The color filter 2 is disposed on the front side of the LCD module 11. The color filter 2 includes a BM 22, RGB layers 23, 23, and . . . , a transparent electrode part 24, and an alignment film 25, which are disposed on the back of a glass substrate (transparent substrate) 21 in this order.

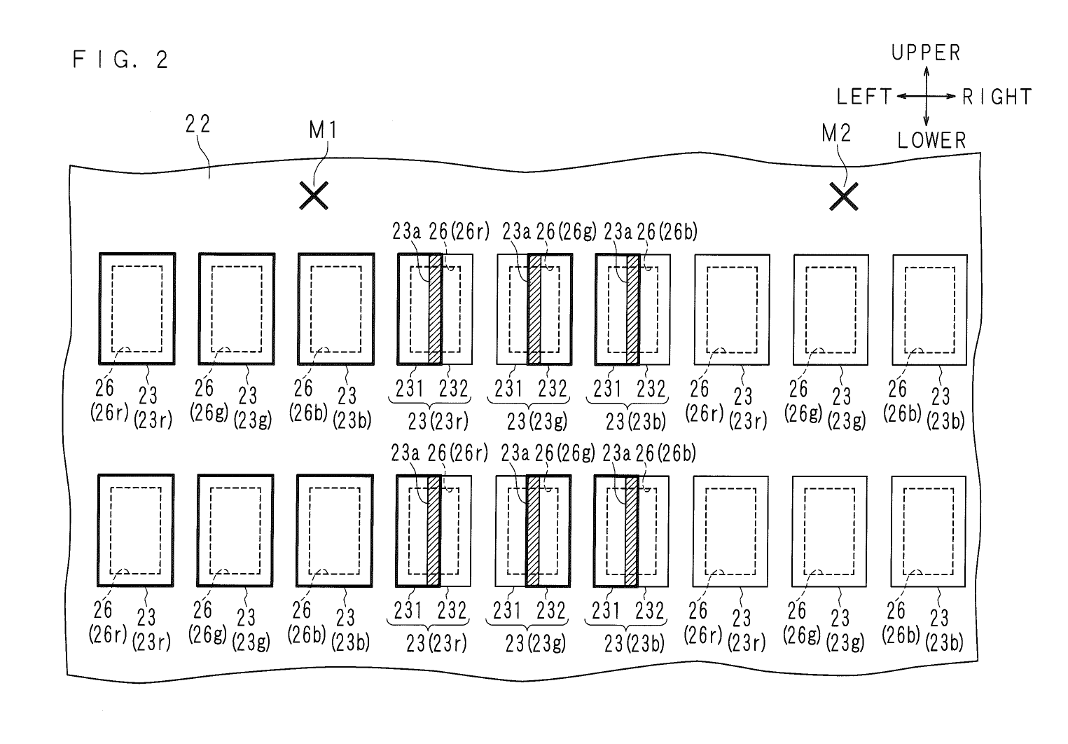

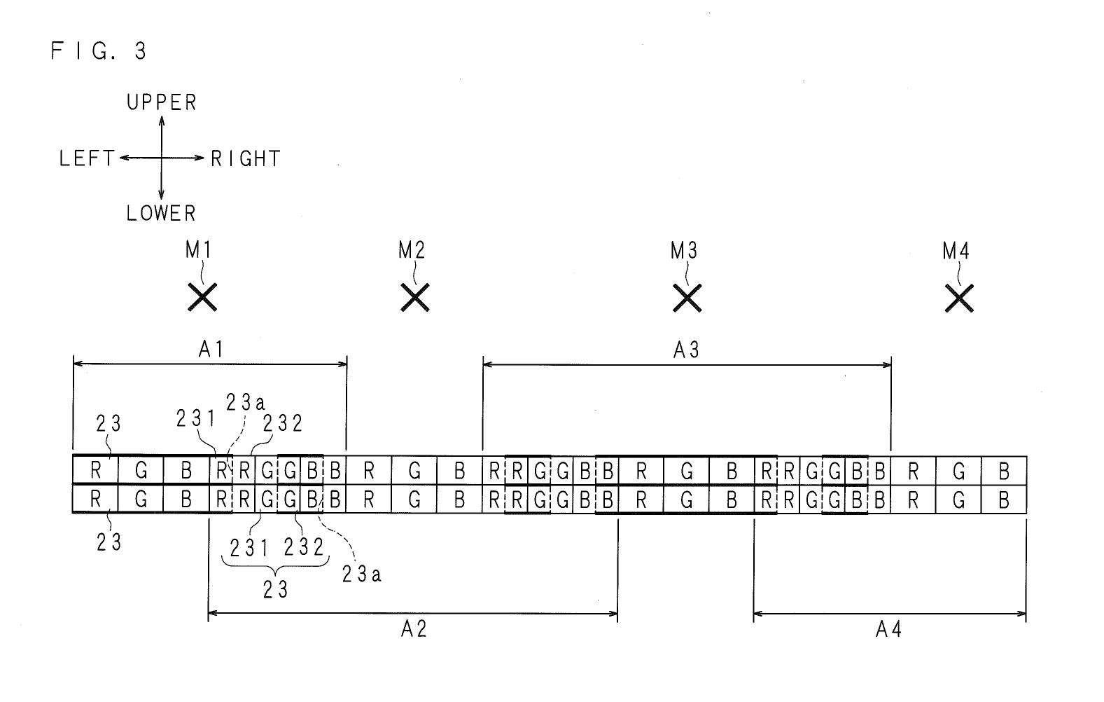

The BM 22 is provided with a plurality of openings 26, 26, and . . . . In addition, the BM 22 is provided with a plurality of alignment marks (not illustrated in FIG. 1). In the present embodiment, a case in which four alignment marks M1 to M4 are provided is exemplified (see FIGS. 2 and 3 which will be described below).

In general, an arrangement of liquid crystal molecules forming the liquid crystal layer 17 is determined by a surface shape of the alignment films 25 and 34. Light made incident on the liquid crystal layer 17 in this state is transmitted through the liquid crystal layer 17 as it is. Herein, when a voltage is applied between the transparent electrode parts 24 and 33 via the thin-film transistor part 32, the arrangement of liquid crystal molecules forming the liquid crystal layer 17 is changed. Light made incident on the liquid crystal layer 17 in this state is polarized by the liquid crystal layer 17.

The backlight unit 12 emits light to the front side. The light emitted from the backlight unit 12 is transmitted through the diffusion plate 13, and thus to be diffused. The diffused light is transmitted through the polarizing plate 14 and the TFT substrate 3 in this order, and then is made incident on the liquid crystal layer 17. The light made incident on the liquid crystal layer 17 is transmitted through the liquid crystal layer 17 as it is, or is diffused and then made incident on the color filter 2. The light made incident on the color filter 2 is transmitted through the alignment film 25 and the transparent electrode part 24, and then is made incident on the RGB layers 23, 23, and . . . , or is blocked by the BM 22. The light (hereinafter, referred to as a colored light) transmitted through the RGB layers 23, 23, and . . . is transmitted through the glass substrate 21 to be emitted. When the light is transmitted through the liquid crystal layer 17 as it is, the colored light emitted from the color filter 2 is blocked by the polarizing plate 15. When the light being polarized by the liquid crystal layer 17, the colored light emitted from the color filter 2 is transmitted through the polarizing plate 15 and the protective glass 16 in this order to be emitted to an outside.

Next, a configuration of the color filter 2 will be described in detail with reference to FIG. 1 and FIG. 2 to be described below.

FIG. 2 is a front view schematically illustrating the configuration of the color filter 2 according to Embodiment 1 of the present invention. FIG. 2 illustrates the BM 22, the RGB layers 23, 23, and . . . , and the alignment marks M1 and M2.

Hundreds of openings 26, 26, and . . . are arranged in a lattice shape in each of the horizontal direction (one direction) and the vertical direction (the other direction). Each opening 26 is formed in a rectangular shape.

Further the openings 26, 26, and . . . are arranged in a zigzag shape.

Each RGB layer 23 is formed in a rectangular shape larger than the opening 26. One RGB layer 23 closes one opening 26. At this time, the RGB layer 23 is filed in the opening 26. In addition, a peripheral edge part of the RGB layer 23 is overlapped with a peripheral edge part of the opening 26 (that is, a portion of the BM 22).

Three openings 26, 26, and . . . adjacent to each other in the horizontal direction correspond to each one pixel of the color image. FIG. 1 illustrates six openings 26, 26, and . . . of two pixels, and FIG. 2 illustrates a total of eighteen openings 26, 26, and . . . of three pixels in the horizontal direction, and two pixels in the vertical direction. Three openings 26, 26, and . . . correspond to the RGB three primary colors.

Hereinafter, when identifying the RGB layer 23 by a color, a red RGB layer 23 is referred to as an R layer 23r, a green RGB layer 23 is referred to as a G layer 23g, and a blue RGB layer 23 is referred to as a B layer 23b. For three openings 26, 26, and . . . of one pixel, the R layer 23r, the G layer 23g, and the B layer 23b are disposed from a left side to a right side in this order. When the RGB layer 23 disposed in the opening 26 is the R layer 23r, the G layer 23g, or the B layer 23b, hereinafter, the opening 26 is referred to as an opening 26r, an opening 26g, and an opening 26b.

Each RGB layer 23 according to one pixel of the horizontal central part illustrated in FIG. 2 has colored convex parts 23a (hatched portions in FIG. 2) at the horizontal central part. The colored convex part 23a is a stepped portion in a surface of the RGB layer 23. The colored convex part 23a is formed in a straight line shape over both vertical end parts at the horizontal central part of the RGB layer 23. Namely, the colored convex part 23a is formed in a line shape along the peripheral edge part of the opening 26 over both vertical end parts at the horizontal central part of the RGB layer 23.

In the present embodiment, the colored convex part 23a is disposed at a central position of the RGB layer 23 in the horizontal direction thereof. However, the horizontal central part of the RGB layer 23 is not limited to the central position of the RGB layer 23 in the horizontal direction thereof.

A left half of the RGB layer 23 including the colored convex part 23a thereof is referred to as a left exposure part 231 below. Also, a right half of the RGB layer 23 including the colored convex part 23a thereof is referred to as a right exposure part 232 below. The left exposure part 231 and the right exposure part 232 are portions formed by exposing with reference to two alignment marks (for example, alignment marks M1 and M2) different from each other as described below. The colored convex part 23a is a portion twice exposed by referring to the two alignment marks.

Each RGB layer 23 according to one pixel of a left end part illustrated in FIG. 2 is a portion formed by exposing with reference to the alignment mark M1. Meanwhile, each RGB layer 23 according to one pixel of a right end part illustrated in FIG. 2 is a portion formed by exposing with reference to the alignment mark M2.

In FIG. 2, the portions exposed by referring to the alignment mark M1 are illustrated by surrounding with a thick solid line, and the portions exposed by referring to the alignment mark M2 are illustrated by surrounding with a thin solid line.

FIG. 3 is a front view schematically illustrating an arrangement of the RGB layers 23, 23, and . . . .

FIG. 3 illustrates the RGB layers 23, 23, and . . . of seven pixels in the horizontal direction, and two pixels in the vertical direction. Each square illustrated by the solid line in FIG. 3 represents each RGB layer 23. Colors of each RGB layer 23 are illustrated by alphabetical characters of ‘R’, ‘G’, and ‘B’. Herein, for the RGB layer 23 having the colored convex part 23a (furthermore the left exposure part 231 and the right exposure part 232), the colors thereof are illustrated by the alphabetical characters of ‘RR’, ‘GG’, and ‘BB’. The colored convex parts 23a are illustrated by broken lines.

A range illustrated by an arrow A1 in FIG. 3 represents a range exposed through a left side mask part 421 to be described below, with reference to the alignment mark M1. In the range illustrated by the arrow A1, the RGB layer 23, the left exposure part 231, or the right exposure part 232 formed by exposing with reference to the alignment mark M1 is illustrated by a square horizontal line of the thick solid line.

A range illustrated by an arrow A2 represents a range exposed through a central mask part 422 to be described below, with reference to the alignment mark M2. In the range illustrated by the arrow A2, the RGB layer 23, the left exposure part 231, or the right exposure part 232 formed by exposing with reference to the alignment mark M2 is illustrated by the square horizontal line of the thin solid line.

A range illustrated by an arrow A3 represents a range exposed through the central mask part 422, with reference to an alignment mark M3. In the range illustrated by the arrow A3, the RGB layer 23, the left exposure part 231, or the right exposure part 232 formed by exposing with reference to the alignment mark M3 is illustrated by the square horizontal line of the thick solid line.

A range illustrated by an arrow A4 represents a range exposed through a right side mask part 422 to be described below, with reference to the alignment mark M4. In the range illustrated by the arrow A4, the RGB layer 23, the left exposure part 231, or the right exposure part 232 formed by exposing with reference to the alignment mark M4 is illustrated by the square horizontal line of the thin solid line.

As illustrated in FIGS. 2 and 3, in the color filter 2, two RGB layers 23 and 23 adjacent to each other in the vertical direction are exposed by referring to the same alignment marks M1 to M4.

In addition, for two RGB layers 23 and 23 adjacent to each other in the horizontal direction, at least portions facing each other (for example, the right exposure part 232 on the left side RGB layer 23, and the left exposure part 231 on the right side RGB layer 23) are formed by exposing with reference to the same alignment marks M1 to M4.

Briefly, according to the present embodiment, both of the vertical direction and the horizontal direction do not occur the unnecessarily close arrangement or separated arrangement of the RGB layers 23 and 23 caused by referring to the different alignment marks M1 to M4.

Next, a manufacturing procedure of the color filter 2 will be described.

First, a forming procedure of the BM 22 will be described. The forming procedure of the BM 22 is the same as the conventional BM.

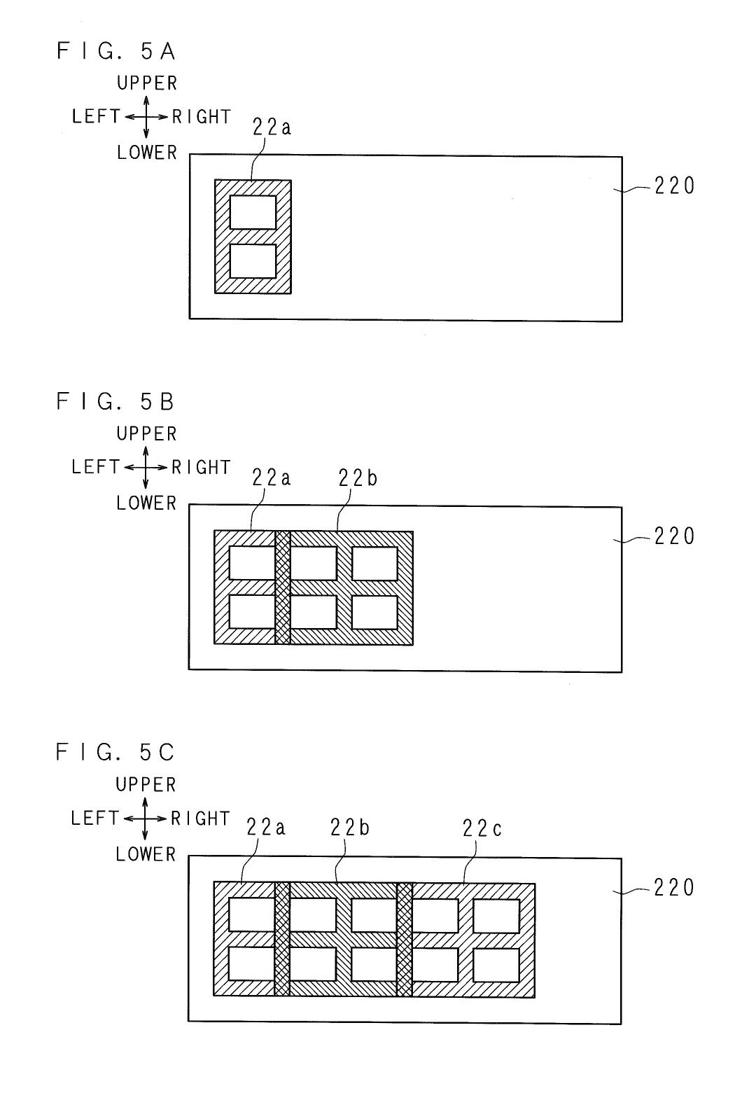

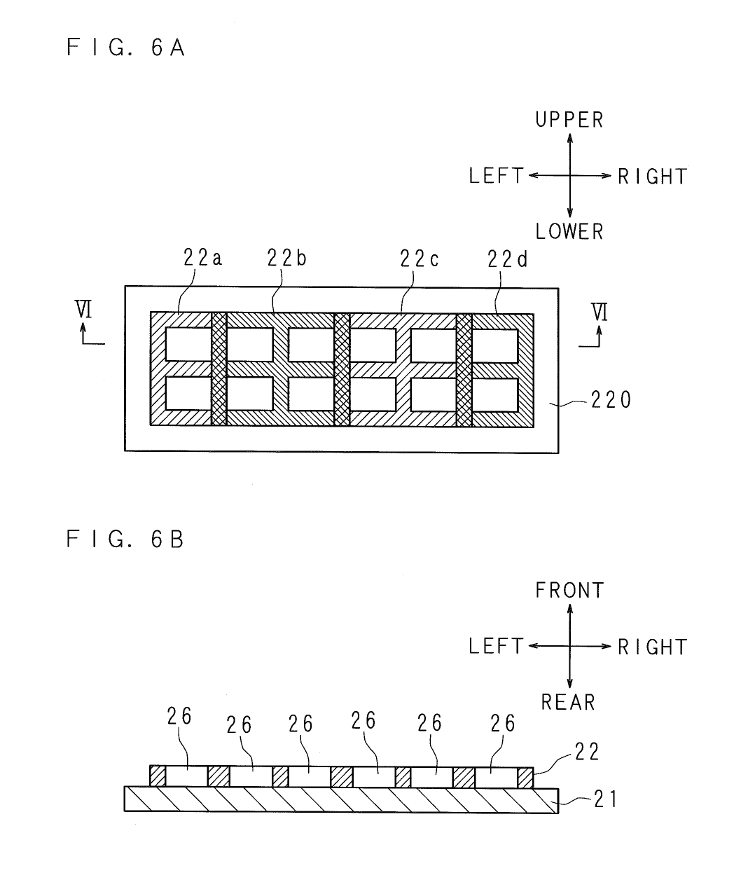

The rectangular glass substrate 21 is prepared, and a light shielding material layer 220 (see FIGS. 5A to 5C and 6A to be described below) is laminated on one surface of the glass substrate 21 by a manufacture.

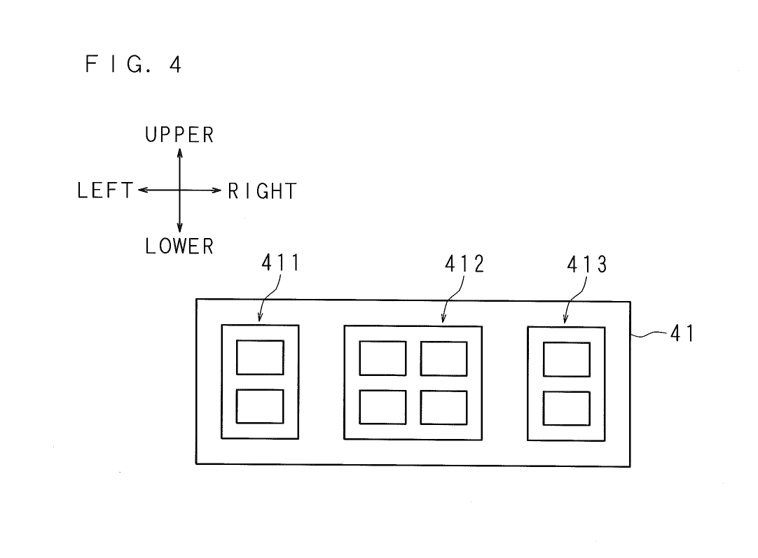

Next, an exposure mask 41 (see next FIG. 4) for patterning the BM 22 is prepared by the manufacture.

FIG. 4 is a front view schematically illustrating a configuration of the exposure mask 41.

The exposure mask 41 of the present embodiment has a left side mask part 411 provided with a mask pattern of the BM 22 to be formed at the left end part of the light shielding material layer 220, a central mask part 412 provided with a mask pattern of the BM 22 to be formed at the left half or the right half of the horizontal central part of the light shielding material layer 220, and the right side mask part 413 provided with a mask pattern of the BM 22 to be formed at the right end part of the light shielding material layer 220.

For simplicity of description, a case in which the respective left side mask part 411 and the right side mask part 413 illustrated in FIG. 4 are provided with a mask pattern of an 8 frame shape corresponding to two openings 26 and 26 adjacent to each other in the vertical direction, and the central mask part 412 is provided with a mask pattern of a cross in square frame shape corresponding to four openings 26, 26, and . . . in the vertical and horizontal directions is exemplified.

Herein, in the present embodiment, each mask pattern actually provided in the exposure mask 41 is a lattice frame shape corresponding to a plurality of the openings 26, 26, and . . . arranged in the vertical and horizontal directions.

FIGS. 5A to 5C and FIGS. 6A and 6B are schematic views for describing the forming procedure of the BM 22. FIGS. 5A to 5C and FIG. 6A are front views, and FIG. 6B is a cross-sectional view taken on line VI-VI of FIG. 6A.

In FIGS. 5A to 5C and FIG. 6A, exposed portions are illustrated by hatching, and twice exposed portions are illustrated by cross hatching.

An exposure is performed on the left end part of the light shielding material layer 220 through the left side mask part 411 by the manufacture (see FIG. 5A). The exposed portion at this time is referred to as an exposure frame 22a below. A shape of the exposure frame 22a is equal to the shape of the mask pattern of the left side mask part 411.

Then, the exposure is performed on the left half of the horizontal central part of the light shielding material layer 220 through the central mask part 412 by the manufacture (see FIG. 5B). The newly exposed portion at this time is referred to as an exposure frame 22b below. The shape of the exposure frame 22b and an exposure frame 22c to be described below is equal to the shape of the mask pattern of the central mask part 412. The exposure frame 22b is provided so that an arrangement position of the left end part (a left frame) of the exposure frame 22b is consistent with the arrangement position of the right end part (a right frame) of the exposure frame 22a. Briefly, the right frame of the exposure frame 22a is exposed again.

Further, the exposure is performed on the right half of the horizontal central part of the light shielding material layer 220 through the central mask part 412 by the manufacture (see FIG. 5C). The newly exposed portion at this time is referred to as the exposure frame 22c below. The exposure frame 22c is provided so that the arrangement position of the left frame of the exposure frame 22c is consistent with the arrangement position of the right frame of the exposure frame 22b. Briefly, the right frame of the exposure frame 22b is exposed again.

Further, the exposure is performed on the right end part of the light shielding material layer 220 through the right side mask part 413 by the manufacture (see FIG. 6A). The exposed portion at this time is referred to as an exposure frame 22d below. The shape of the exposure frame 22d is equal to the shape of the mask pattern of the right side mask part 413. The exposure frame 22d is provided so that the arrangement position of the left frame of the exposure frame 22d is consistent with the arrangement position of the right frame of the exposure frame 22c. Briefly, the right frame of the exposure frame 22c is exposed again.

Thereafter, when removing an unexposed portion of the light shielding material layer 220 with the developing solution, the BM 22 in which the openings 26, 26, and . . . are arranged in parallel is obtained (see FIG. 6B). At this time, interior portions of respective exposure frames 22a to 22d become the openings 26, 26, and . . . . In addition, the twice exposed portion of the exposure frames 22a to 22d becomes the vertical BM.

When forming the BM 22, the alignment marks M1 to M4 are also simultaneously formed. At this time, the respective alignment marks M1 to M4 are formed at an outside (a so-called frame region) of the range corresponding to the display region of the liquid crystal display apparatus 1.

Next, a forming procedure of the RGB layers 23, 23, and . . . will be described.

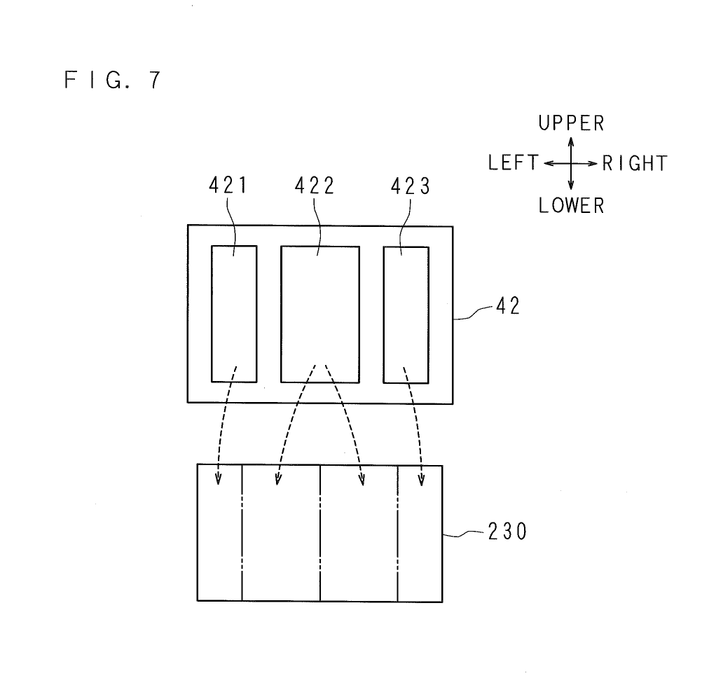

FIG. 7 is a front view schematically illustrating a configuration of an exposure mask 42.

The exposure mask 42 is prepared for patterning the RGB layers 23, 23, and . . . by the manufacture. Then, a colored material layer 230 is laminated on the BM 22 and the glass substrate 21 bared through the openings 26, 26, and . . . by the manufacture.

The exposure mask 42 of the present embodiment has a left side mask part 421 provided with a mask pattern of the RGB layers 23, 23, and . . . to be formed at the left end part of the colored material layer 230, a central mask part 422 provided with a mask pattern of the RGB layers 23, 23, and . . . to be formed at the left half or the right half of the horizontal central part of the colored material layer 230, and a right side mask part 423 provided with a mask pattern of the RGB layers 23, 23, and . . . to be formed at the right end part of the colored material layer 230.

Hereinafter, when identifying the exposure mask 42, the left side mask part 421, the central mask part 422, and the right side mask part 423 corresponding to the R layers 23r, 23r, and . . . , the G layers 23g, 23g, and . . . , and the B layers 23b, 23b, and . . . , symbols of V, ‘g’, and ‘b’ are denoted thereto.

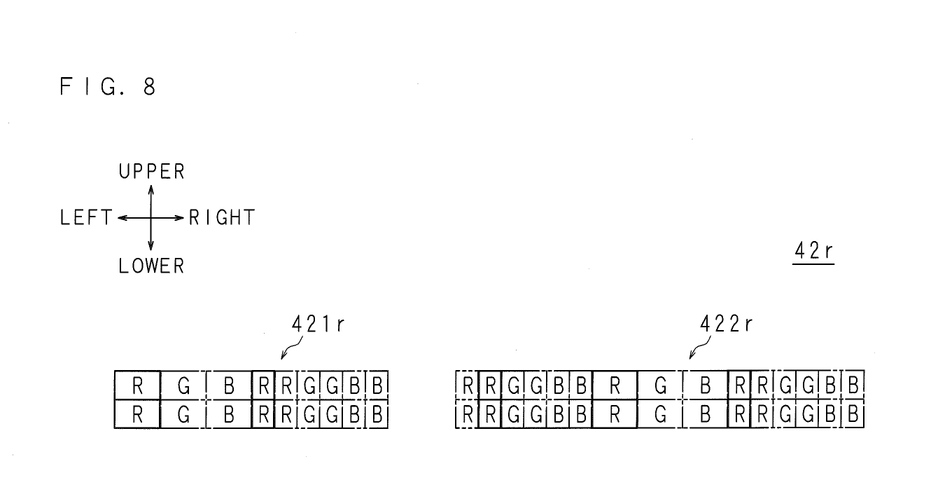

FIG. 8 is a front view schematically illustrating the mask patterns provided in a left side mask part 421r and a central mask part 422r of an exposure mask 42r for pattering the R layers 23r, 23r, and . . . . The portions illustrated by the thick solid lines in FIG. 8 are the mask patterns. The arrangement of the mask patterns illustrated in FIG. 8 corresponds to the arrangement of the RGB layers 23, 23, and . . . illustrated in FIG. 3. The portions illustrated by dashed-two dotted lines in FIG. 8 represent the arrangement of the RGB layers 23, 23, and . . . illustrated in FIG. 3.

For simplicity of description, the left side mask part 421r illustrated in FIG. 8 is provided with the mask pattern of the R layers 23r, 23r, and . . . of each two pixels in the vertical and horizontal directions, and the central mask part 422r is provided with the mask pattern of the R layers 23r, 23r, and . . . of two pixels in the vertical direction, and three pixels in the horizontal direction.

For the horizontal direction, the mask pattern of the R layer 23r of one pixel on the right side of the left side mask part 421r and the mask pattern of the R layer 23r of one pixel on the left end part of the central mask part 422r are in a relation complementary to each other. Specifically, the left side mask part 421r is provided with the mask pattern corresponding to the left exposure part 231 of the R layer 23r, and the central mask part 422r is provided with the mask pattern corresponding to the right exposure part 232 of the R layer 23r.

In addition, for the horizontal direction, the mask pattern of the R layer 23r of one pixel on the left end part of the central mask part 422r and the mask pattern of the R layer 23r of one pixel on the right end part of the central mask part 422r are in the relation complementary to each other.

Further, for the horizontal direction, the mask pattern of the R layer 23r of one pixel on the right end part of the central mask part 422r and the mask pattern of the R layer 23r of one pixel on the left side of a right side mask part 423r are in the relation complementary to each other.

For the horizontal direction, the mask pattern of the R layer 23r of one pixel on the left side of the left side mask part 421r, the mask pattern of the R layer 23r of one pixel on the central part of the central mask part 422r, and the mask pattern of the R layer 23r of one pixel on the right side of the right side mask part 423r correspond to the R layer 23r which does not have the colored convex part 23a.

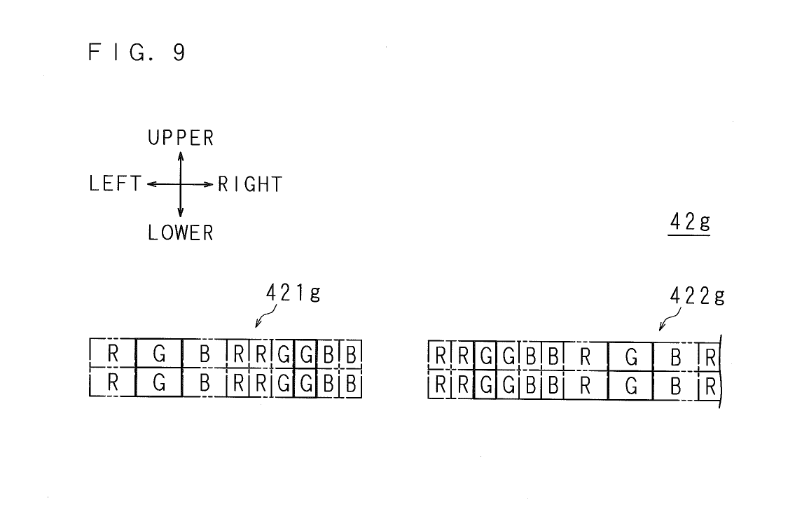

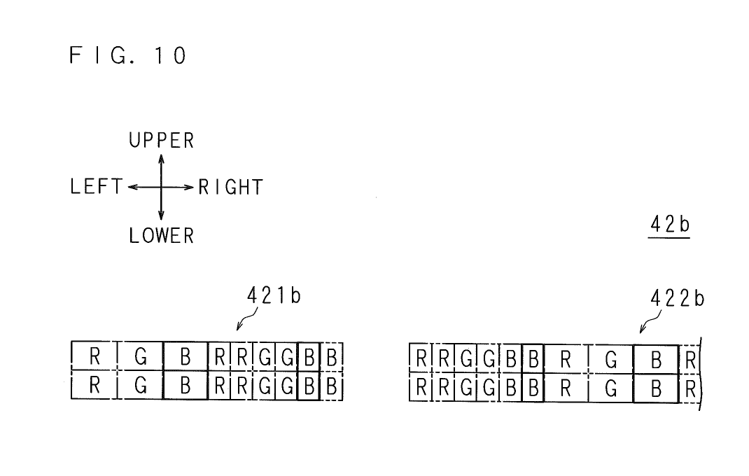

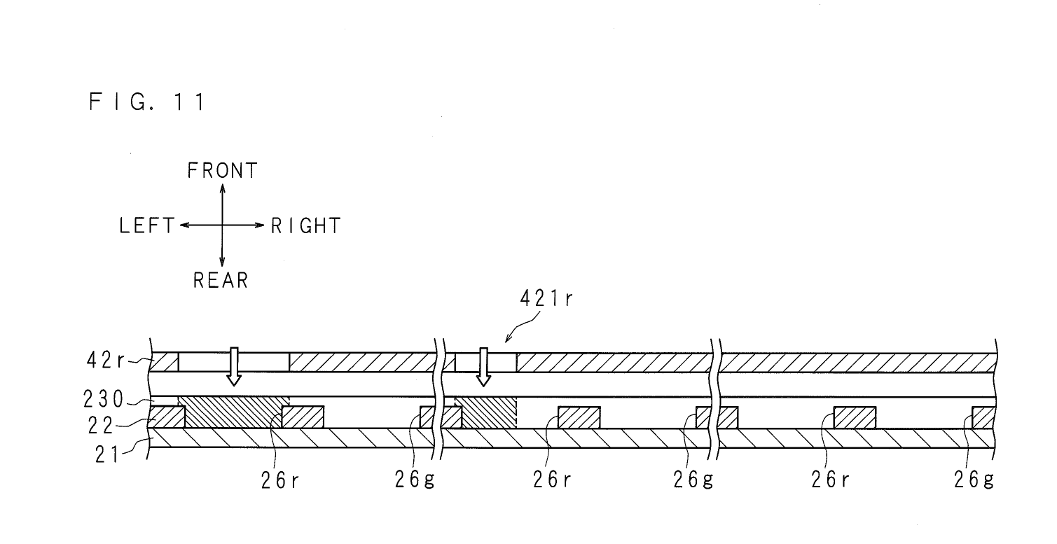

FIG. 9 is a front view schematically illustrating the mask patterns provided in a left side mask part 421g and a central mask part 422g of an exposure mask 42g for pattering the G layers 23g, 23g, and . . . .

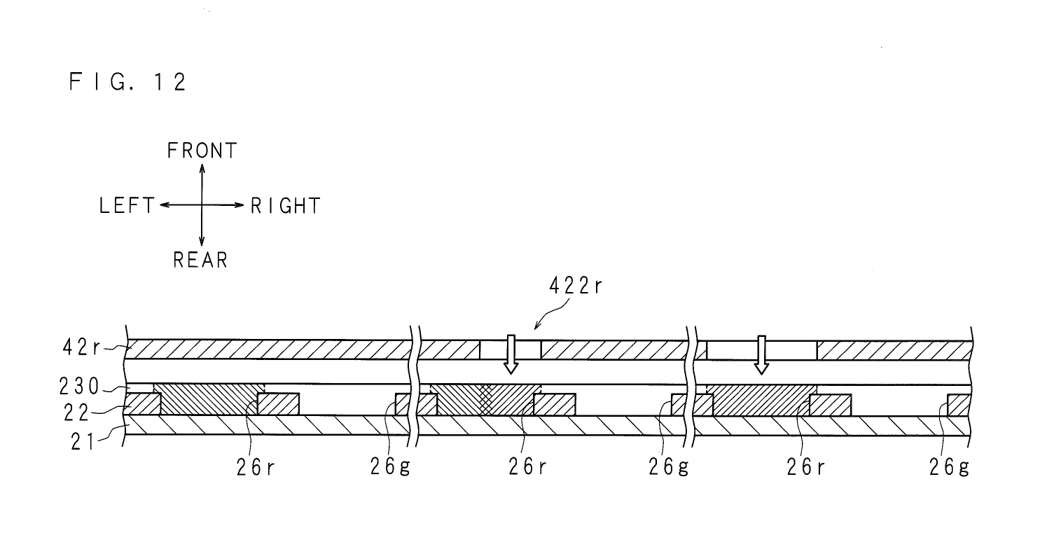

FIG. 10 is a front view schematically illustrating the mask patterns provided in a left side mask part 421b and a central mask part 422b of an exposure mask 42b for pattering the B layers 23b, 23b, and . . . .

FIGS. 9 and 10 correspond to FIG. 8. Accordingly, the portions illustrated by the thick solid lines in FIGS. 9 and 10 are the mask patterns. The arrangement of the mask patterns illustrated in FIGS. 9 and 10 and the arrangement of the RGB layers 23, 23, and . . . illustrated in FIG. 3 correspond to each other. The portions illustrated by the dashed-two dotted lines in FIGS. 9 and 10 represent the arrangement of the RGB layers 23, 23, and . . . illustrated in FIG. 3.

The configuration of the exposure masks 42g and 42b are substantially the same as that of the exposure mask 42r.

For example, for the horizontal direction, the mask pattern of the G layer 23g of one pixel on the right side of the left side mask part 421g and the mask pattern of the G layer 23g of one pixel on the left end part of the central mask part 422g are in the relation complementary to each other. Specifically, the left side mask part 421g is provided with the mask pattern corresponding to the right exposure part 232 of the G layer 23g, and the central mask part 422g is provided with the mask pattern corresponding to the left exposure part 231 of the G layer 23g.

Next, a forming procedure of the R layers 23r, 23r, and . . . will be described.

After forming the BM 22, the red colored material layer 230 is laminated on the BM 22 and the glass substrate 21 bared through the openings 26, 26, and . . . by the manufacture.

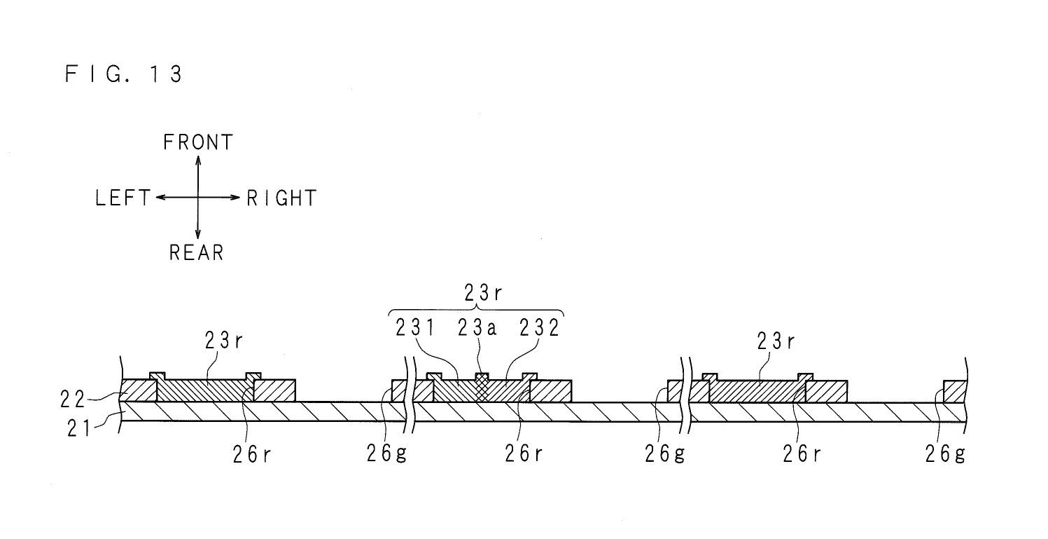

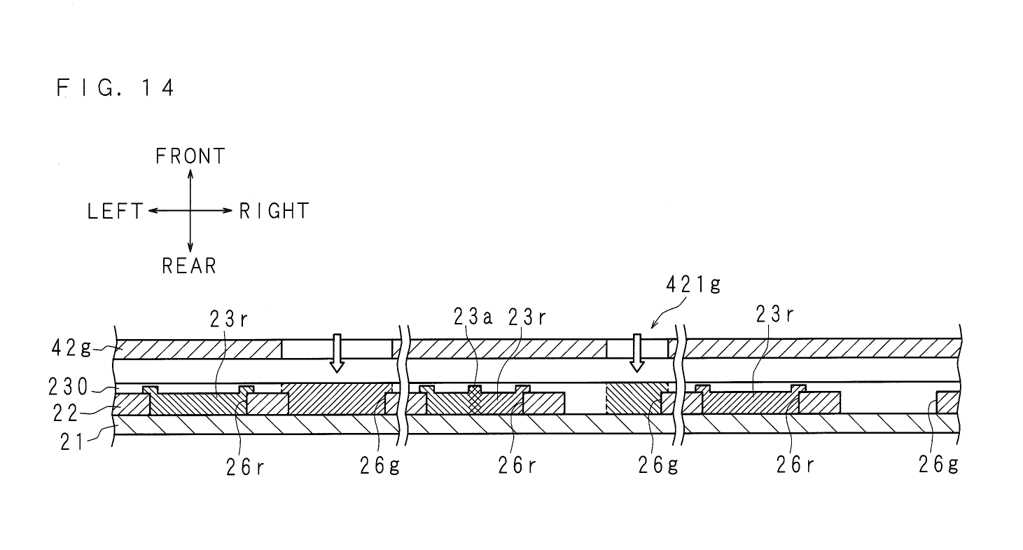

FIGS. 11 to 13 are schematic cross-sectional views for describing the forming procedure of the R layers 23r, 23r, and . . . . FIGS. 11 and 12 include cross-sectional views of the colored material layer 230. Herein, portions denoted by right downward-sloping hatchings in the colored material layer 230 mean a portion formed by exposing with reference to the alignment mark M1, and portions denoted by right upward-sloping hatchings mean a portion formed by exposing with reference to the alignment mark M2. Portions denoted by the cross hatchings mean the twice exposed portions. In addition, portions denoted by the broken lines mean a boundary between the exposed portion and the unexposed portion, and white portions mean the unexposed portion.

The exposure is performed on the left end part of the colored material layer 230 through the left side mask part 421r, with reference to the alignment mark M1 by the manufacture (see the range illustrated by the arrow A1 in FIG. 3 and FIG. 11).

Then, the exposure is performed on the left half of the horizontal central part of the colored material layer 230 through the central mask part 422r, with reference to the alignment mark M2 by the manufacture (see the range illustrated by the arrow A2 in FIG. 3 and FIG. 12). At this time, the exposure is performed again on a part of the portion on which one previous exposure was performed (in this case, specifically the exposure illustrated in FIG. 11).

Further, the exposure is performed on the right half of the horizontal central part of the colored material layer 230 through the central mask part 422r, with reference to the alignment mark M3 by the manufacture (see the range illustrated by the arrow A3 in FIG. 3). At this time, the exposure is performed again on a part of the portion on which the exposure illustrated in FIG. 12 was performed in FIG. 12.

Furthermore, the exposure is performed on the right end part of the colored material layer 230 through the right side mask part 423r, with reference to the alignment mark M4 by the manufacture (see the range illustrated by the arrow A4 in FIG. 3). Also at this time, the exposure is performed again on a part of the portion on which one previous exposure was performed.

The twice exposed portion is located at the horizontal central part to form the R layer 23r. That is, this portion is a portion in which the colored convex part 23a is generated.

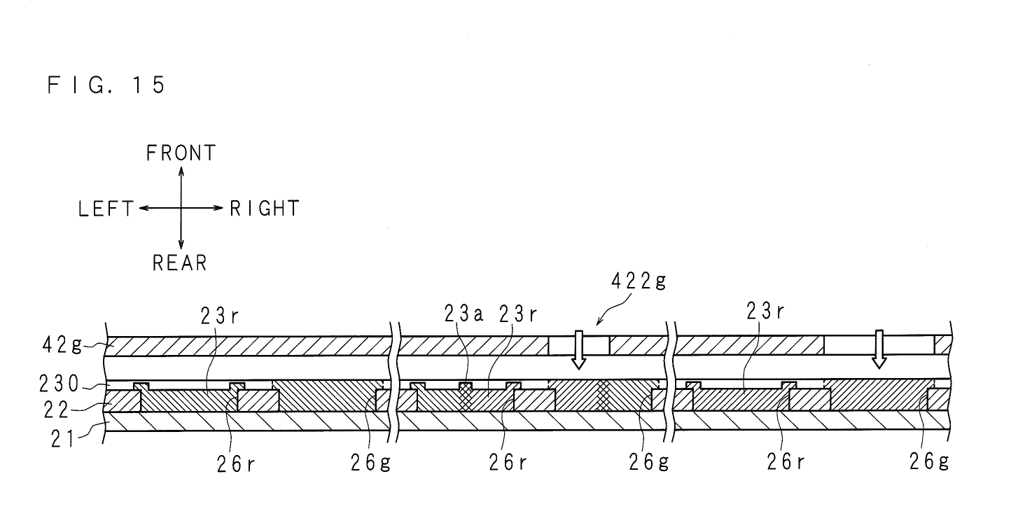

Thereafter, when removing the unexposed portion of the colored material layer 230 with the developing solution, the R layers 23r, 23r, and . . . are obtained (see FIG. 13).

In this regard, it is difficult for the twice exposed colored material layer 230 to be removed compared to the only once exposed colored material layer 230. Therefore, the colored convex parts 23a are generated in some of the R layers 23r, 23r, and . . . . For the R layer 23r, a thickness of a portion having the colored convex part 23a is thicker by only about 1% to 2% than the thickness of the portion which does not have the colored convex part 23a.

Accordingly, an adverse effect (for example, display unevenness) applied to the display of the color image by the colored convex parts 23a, 23a, and . . . is slight.

Herein, a case in which a positional shift occurs during exposing will be described.

For example, after the exposure (the exposure of the range illustrated by the arrow A1 in FIG. 3, see FIG. 11) referring to the alignment mark M1 is performed at a correct position, when an exposure is performed (the exposure of the range illustrated by the arrow A2 in FIG. 3, see FIG. 12) referring to the alignment mark M2 in a state in which the positional shift to the left side (or the right side) from the correct position occurs, the horizontal width of the colored convex part 23a generated at the boundary between both exposed portions is increased (or decreased). The adverse effect applied to the display of the color image by the colored convex part 23a having a long horizontal width is larger than that by the colored convex part 23a having a short horizontal width. However, thereafter, the exposure (the exposure of the range illustrated by the arrow A3 in FIG. 3) referring to the alignment mark M3 is further performed at the correct position, such that the horizontal width of the colored convex part 23a occurring at the boundary between the exposed portion thereof and the portion in which the exposure referring to the alignment mark M2 is performed is decreased (or increased). Accordingly, generating only the wide colored convex parts 23a, 23a, and . . . on the whole of the display region of the liquid crystal display apparatus 1 may not occur.

Next, a forming procedure of the G layers 23g, 23g, and . . . will be described.

After forming the R layers 23r, 23r, and . . . , the green colored material layer 230 is laminated on the BM 22 and the glass substrate 21 bared through the openings 26, 26, and . . . by the manufacture.

FIGS. 14 to 16 are schematic cross-sectional views for describing the forming procedure of the G layers 23g, 23g, and FIGS. 14 to 16 correspond to FIGS. 11 to 13.

The exposure is performed on the left end part of the colored material layer 230 through the left side mask part 421g, with reference to the alignment mark M1 by the manufacture (see the range illustrated by the arrow A1 in FIG. 3 and FIG. 14).

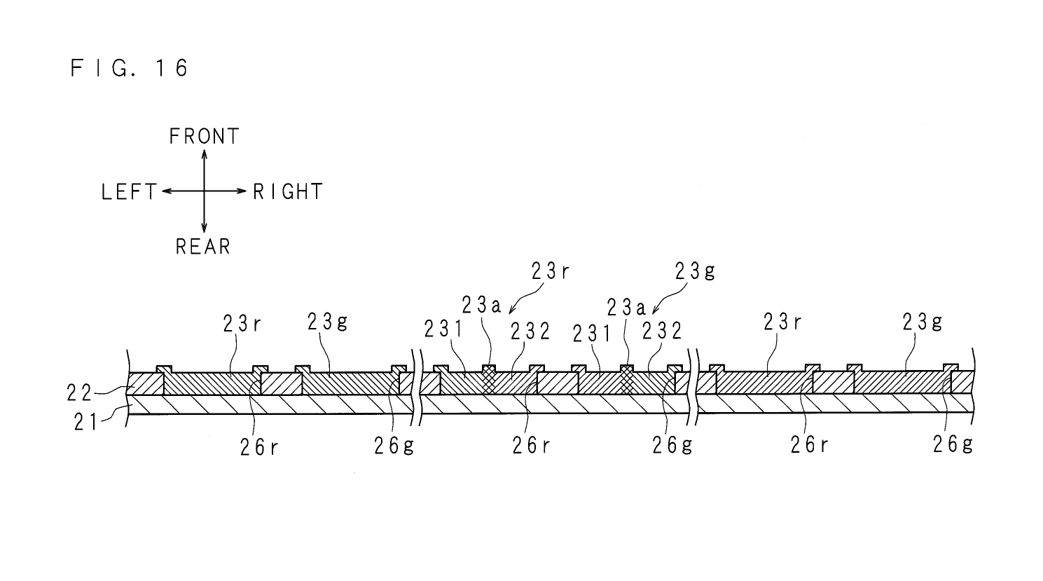

Then, the exposure is performed on the left half of the horizontal central part of the colored material layer 230 through the central mask part 422g, with reference to the alignment mark M2 by the manufacture (see the range illustrated by the arrow A2 in FIG. 3 and FIG. 15). Also at this time, the exposure is performed again on a part of the portion on which one previous exposure was performed (in this case, specifically the exposure illustrated in FIG. 14).

Further, the exposure is performed on the right half of the horizontal central part of the colored material layer 230 through the central mask part 422g, with reference to the alignment mark M3 by the manufacture (see the range illustrated by the arrow A3 in FIG. 3). At this time, the exposure is performed again on a part of the portion on which the exposure illustrated in FIG. 12 was performed in FIG. 12.

Furthermore, the exposure is performed on the right end part of the colored material layer 230 through the right side mask part 423g, with reference to the alignment mark M4 by the manufacture (see the range illustrated by the arrow A4 in FIG. 3). Also at this time, the exposure is performed again on a part of the portion on which one previous exposure was performed.

The twice exposed portion is located at the horizontal central part of a portion to form the G layer 23g. That is, this portion is a portion in which the colored convex part 23a is generated.

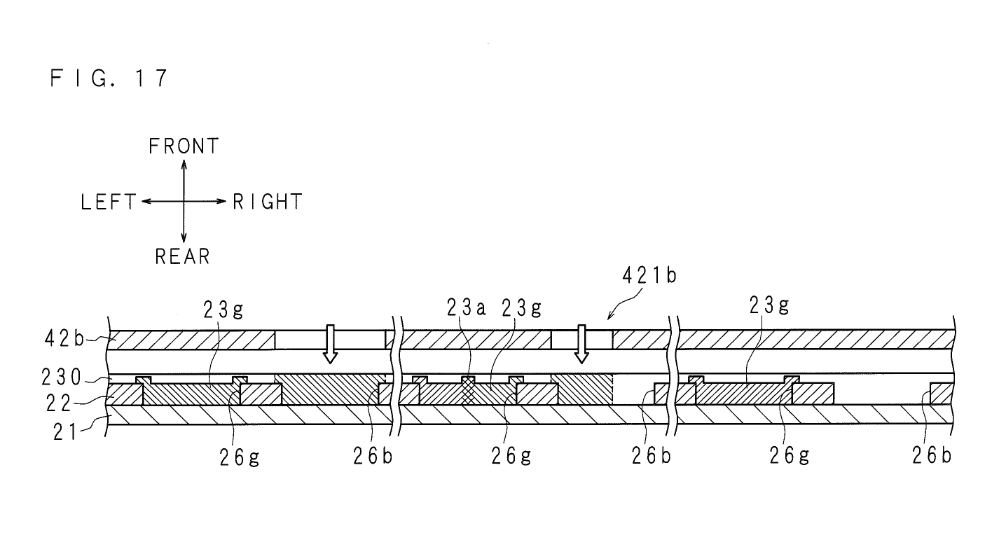

Thereafter, when removing the unexposed portion of the colored material layer 230 with the developing solution, the G layers 23g, 23g, and . . . are obtained (see FIG. 16). Some of the G layers 23g, 23g, and . . . have the colored convex part 23a, respectively.

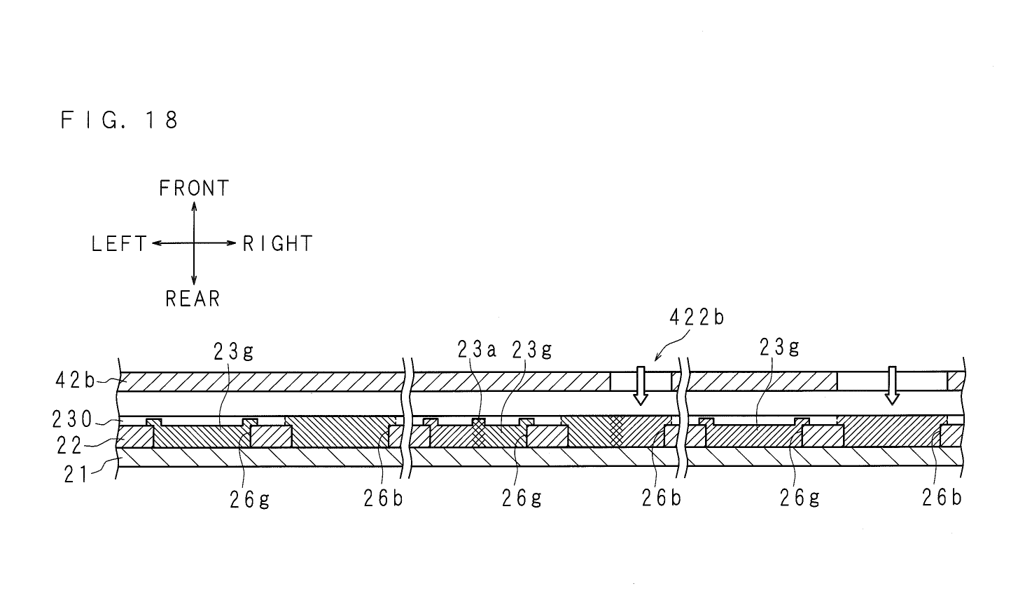

FIGS. 17 to 19 are schematic cross-sectional views for describing a forming procedure of the B layers 23b, 23b, and . . . . FIGS. 17 to 19 correspond to FIGS. 11 to 13 and FIGS. 14 to 16.

The forming procedure of the B layers 23b, 23b, and . . . is substantially the same as the forming procedure of the R layers 23r, 23r, and . . . or the G layers 23g, 23g, and . . . .

In this regard, an exposure process illustrated in FIG. 11 and the exposure process illustrated in FIG. 12 include a first exposure process and a second exposure process in the embodiments of the present invention. The exposure process illustrated in FIG. 14 and the exposure process illustrated in FIG. 15 include a third exposure process and a fourth exposure process in the embodiments of the present invention.

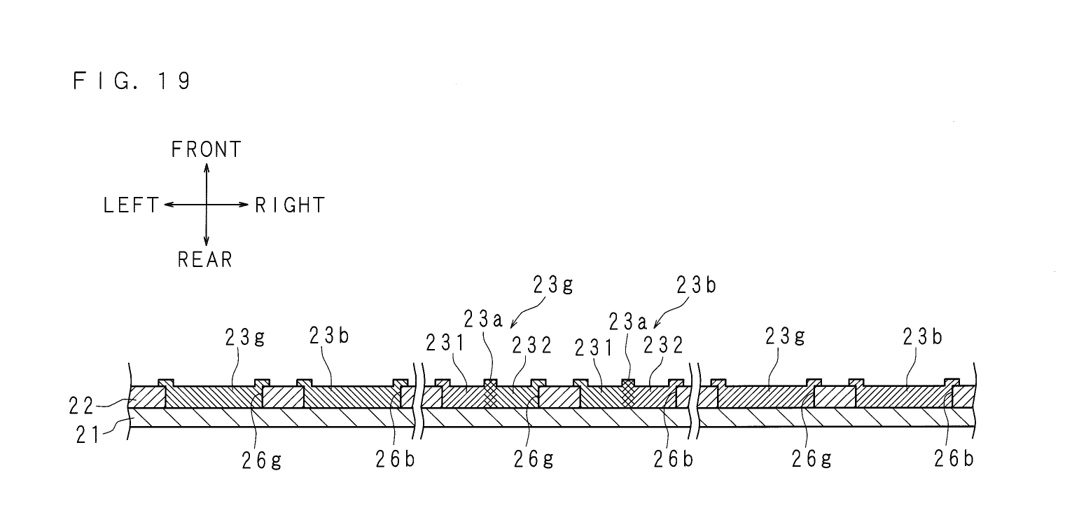

Herein, if the exposure process illustrated in FIG. 14 and the exposure process illustrated in FIG. 15 are considered to include the first exposure process and the second exposure process in the embodiments of the present invention, the exposure process illustrated in FIG. 17 and the exposure process illustrated in FIG. 18 include the third exposure process and the fourth exposure process in the embodiments of the present invention.

Specifically, the exposure process illustrated in FIG. 14 includes the first exposure process of performing an exposure on the colored material layer 230 corresponding to the right exposure part 232 of the G layer 23g to be disposed in the opening 26g using the alignment mark M1. Also, the exposure process illustrated in FIG. 15 includes the second exposure process of performing an exposure on the colored material layer 230 corresponding to the left exposure part 231 of the G layer 23g to be disposed in the opening 26g using the alignment mark M2.

Further, the exposure process illustrated in FIG. 17 includes the third exposure process of performing an exposure on the colored material layer 230 corresponding to the left exposure part 231 of the B layer 23b to be disposed in the opening 26b adjacent to the horizontal right side in the opening 26g using the alignment mark M1. The exposure process illustrated in FIG. 18 includes the fourth exposure process of performing an exposure on the colored material layer 230 corresponding to the right exposure part 232 of the B layer 23b to be disposed in the opening 26b using the alignment mark M4.

Herein, the color filter 2 is compared with the conventional color filter.

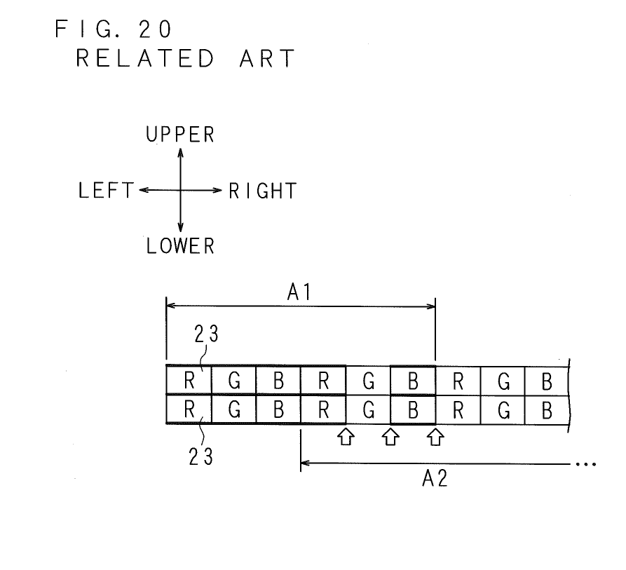

FIG. 20 is a front view schematically illustrating an arrangement of the RGB layers 23, 23, and . . . included in the conventional color filter. FIG. 20 corresponds to two pixels in the vertical direction and three pixels of the left end part in FIG. 3.

In manufacturing the conventional color filter, the BM 22 is patterned by the same procedure as the embodiments of the present invention. At this time, the alignment marks M1 to M4 are provided thereon.

Next, the RGB layers 23, 23, and . . . are patterned by the same procedure as that of the embodiments of the present invention. Herein, all the RGB layers 23 formed at this time do not have the colored convex part 23a. The reason is that the left exposure part 231 and the right exposure part 232 which are formed by exposing with reference to the alignment marks M1 to M4 different from each other are not present on the RGB layer 23.

Accordingly, as illustrated in FIG. 20, in the conventional color filter, two RGB layers 23 and 23 adjacent to each other in the horizontal direction are not always necessary to be formed by exposing with reference to the same alignment marks M1 to M4. Therefore, at the position illustrated by a white arrow in FIG. 20, the unnecessarily close arrangement or separated arrangement of the RGB layers 23 and 23 caused by referring to the different alignment marks M1 to M4 may occur. Specifically, since the RGB layers 23 and 23 are close to or apart from each other by about 3 μm from the correct arrangement position, it is necessary for the vertical BM to have a horizontal width of about 30 μm.

Meanwhile, in the color filter 2, a part of the RGB layers 23, 23, and . . . (for example, at least one of the RGB layers 23 and 23 which may occur the unnecessarily close arrangement or separated arrangement caused by referring to the different alignment marks M1 to M4 of the RGB layers 23 and 23 in the conventional color filter) is formed by the procedure different from the prior art. That is, the colored material layer 230 corresponding to a part including the left side (or the right side) of the RGB layer 23 and the colored material layer 230 corresponding to the residual part of the RGB layer 23 are exposed by referring to the different alignment marks M1 to M4. In other words, the left exposure part 231 and the right exposure part 232 included in the RGB layer 23 are formed by referring to the alignment marks M1 to M4 different from each other. Therefore, the RGB layers 23 and 23 adjacent to each other do not occur the unnecessarily close arrangement or separated arrangement caused by referring to the different alignment marks M1 to M4.

Accordingly, the color filter 2 may have a shorter horizontal width of the BM 22 (that is, the vertical BM) between the RGB layers 23 and 23 adjacent to each other in the horizontal direction than the conventional color filter. Specifically, it is possible to shorten the horizontal width thereof from 30 μm for the conventional color filter to 27 μm. As a result, it is possible to improve the aperture ratio of the BM 22.

The liquid crystal display apparatus 1 including the above-described color filter 2 may improve usage efficiency of light emitted by the backlight unit 12 when displaying the color image.

In this regard, the left exposure part 231 and the right exposure part 232 included in the RGB layer 23 may be unnecessarily arranged close to or apart from each other. However, if the horizontal width of the left exposure part 231 and the right exposure part 232 is sufficiently long, there is no longer a possibility that the left exposure part 231 and the right exposure part 232 are arranged apart from each other and a portion of the opening 26 is not covered by the RGB layer 23.

Further, the mask patterns corresponding to the twice exposed portion during forming the RGB layers 23, 23, and . . . , and the vicinity around the portion may be formed in a densely arranged tile shape. By compensating (so-called ‘mosaic joining’) the densely arrangement of the tiles by such mask patterns each other, the colored convex part 23a may be formed in a gently raised shape, and may be barely viewed.

The color filter 2 of the present embodiment has the colored convex part 23a which is a convexed step part, but it is not limited thereto. For example, the color filter 2 may have a concaved step part instead of the colored convex part 23a. The concaved step part is generated when the colored material layer 230 twice exposed during forming the RGB layer 23 is easily removed compared to the colored material layer 230 only once exposed. Otherwise, the color filter 2 may have a configuration in which a color tinge between the portion twice exposed by referring to two alignment marks and a portion once exposed by referring to one alignment mark in the RGB layer 23 is different from each other, but there is no step between these portions. This may occur when the color of the colored material layer 230 is changed by the exposure.

### Embodiment 2

A liquid crystal display apparatus 1 and a color filter 2 of the present embodiment have substantially the same configuration as the liquid crystal display apparatus 1 and the color filter 2 of Embodiment 1. Hereinafter, a difference from Embodiment 1 will be described, and the other parts corresponding to Embodiment 1 will be denoted by the same reference numerals, and will not be described.

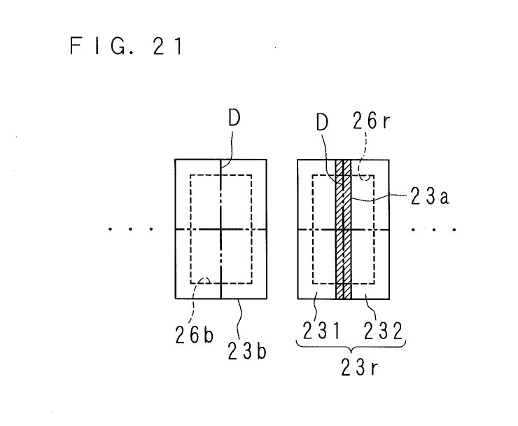

FIG. 21 is a front view schematically illustrating the configuration of the color filter 2 according to Embodiment 2 of the present invention. FIG. 21 corresponds to FIG. 2 of Embodiment 1. Herein, among the openings 26, 26, and . . . illustrated in FIG. 2, the opening 26b included in the openings 26, 26, and . . . of one pixel on an upper left end part, and the opening 26r adjacent to the right side of the opening 26b are extracted in FIG. 21.

The liquid crystal display apparatus described in Japanese Patent Application Laid-open No. 2010-134483 has a plurality of regions (hereinafter, referred to as a domain) in which an alignment orientation of the liquid crystal molecules are different from each other. The domain is achieved by research into the alignment film 25 included in the color filter 2 and the alignment film 34 included in the TFT substrate 3.

The boundary portion of the domains (hereinafter, referred to as a domain boundary line) is non-transparent. Therefore, the domain boundary line according to the alignment film 34 serves as a blockage part for blocking light from being incident on the liquid crystal layer 17, and the domain boundary line according to the alignment film 25 serves as a blockage part for blocking the light transmitted through the liquid crystal layer 17 from being emitted.

The domain boundary line in the present embodiment appears as a crossing line D so as to divide each RGB layer 23 into four in the vertical and horizontal directions.

Therefore, the colored convex part 23a is disposed so as to be located upward of a longitudinal line of the crossing line D. Briefly, the arrangement position of the colored convex part 23a corresponds to the arrangement position of the crossing line D in the vertical direction, and appears to overlap the longitudinal line of the colored convex part 23a and the crossing line D with each other in the front view.

Since the light emitted by the backlight unit 12 is blocked by the crossing line D, it is not made incident on the colored convex part 23a. Otherwise, since the light emitted from the colored convex part 23a is blocked by the crossing line D, it is not emitted to an outside of the liquid crystal display apparatus 1. Therefore, an adverse effect applied to the display of the color image by the colored convex part 23a may be disregarded.

In other words, in order to improve the aperture ratio of the BM 22 without applying the adverse effect to the display of the color image, it is possible to use the blockage part which is conventionally present.

Further, the blockage part according to the embodiments of the present invention is not limited to the domain boundary line. The blockage part may be any part (for example, a light shielding object disposed so as to cut across the arrangement position of the opening 26) as long as it blocks the light from being incident on the liquid crystal layer 17, or blocks the light transmitted through the liquid crystal layer 17 from being emitted. As an example there may be a drain wiring.

### Embodiment 3

A liquid crystal display apparatus 1 and a color filter 2 of the present embodiment have substantially the same configuration as the liquid crystal display apparatus 1 and the color filter 2 of Embodiments 1 and 2. Hereinafter, a difference from Embodiments 1 and 2 will be described, and the other parts corresponding to Embodiments 1 and 2 will be denoted by the same reference numerals, and will not be described.

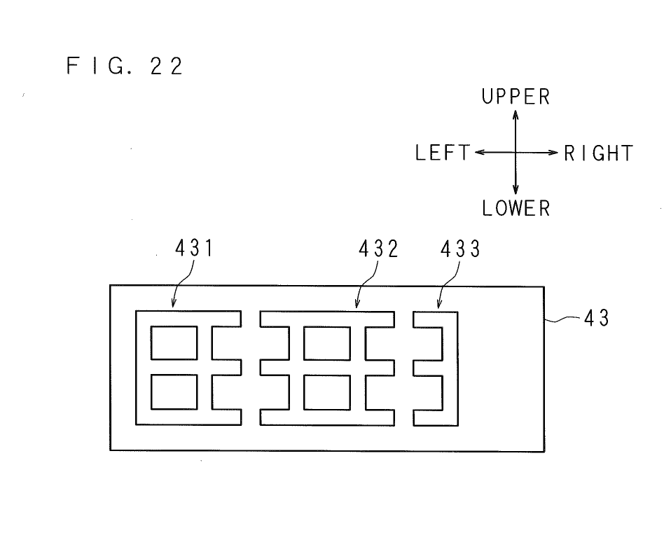

FIG. 22 is a front view schematically illustrating the configuration of an exposure mask 43 for patterning the BM 22 included in the color filter 2 according to Embodiment 3 of the present invention. FIG. 22 corresponds to FIG. 4 of Embodiment 1.

The exposure mask 43 of the present embodiment has a left side mask part 431, a central mask part 432, and a right side mask part 433 corresponding to the left side mask part 411, the central mask part 412, and the right side mask part 413 of the exposure mask 41 of Embodiment 1.

The mask pattern provided in the left side mask part 431 is a shape as an upper frame, a lower frame, and a middle frame of the 8-shaped frame corresponding to two openings 26 and 26 adjacent to each other in the vertical direction respectively extending to the right side. A length of the extension portion is longer than the half of the length of the respective upper frame, lower frame, and middle frame of the 8-shaped frame.

The mask pattern provided in the central mask part 432 is a shape as the upper frame, the lower frame, and the middle frame of the 8-shaped frame corresponding to two openings 26 and 26 adjacent to each other in the vertical direction respectively extending to left and right sides. The length of the extension portion is longer than the half of the length of the respective upper frame, lower frame, and middle frame of the 8-shaped frame.

The mask pattern provided in the right side mask part 433 is a shape as a left half of the 8-shaped frame corresponding to two openings 26 and 26 adjacent to each other in the vertical direction being removed. The length of a portion corresponding to the upper frame, the lower frame, and the middle frame is longer than the half of the length of the respective upper frame, lower frame, and middle frame of the 8-shaped frame.

The right end part and the vicinity of the right end part of the mask pattern provided in the left side mask part 431, and the left end part and the vicinity of the left end part of the mask pattern provided in the central mask part 432 have a shape to be the 8-shaped frame by compensating each other. The left end part and the vicinity of the left end part of the mask pattern provided in the central mask part 432, and the right end part and the vicinity of the right end part of the mask pattern provided in the central mask part 432 have a shape to be the 8-shaped frame by compensating each other. The right end part and the vicinity of the right end part of the mask pattern provided in the central mask part 432, and the left end part and the vicinity of the left end part of the mask pattern provided in the right side mask part 433 have a shape to be the 8-shaped frame by compensating each other.

The shape of each mask pattern provided in the exposure mask 43 is different from the shape of each mask pattern provided in the exposure mask 41 of Embodiment 1, but the shape of the BM 22 provided by using the exposure mask 43 is the same as the shape of the BM 22 provided by using the exposure mask 41.

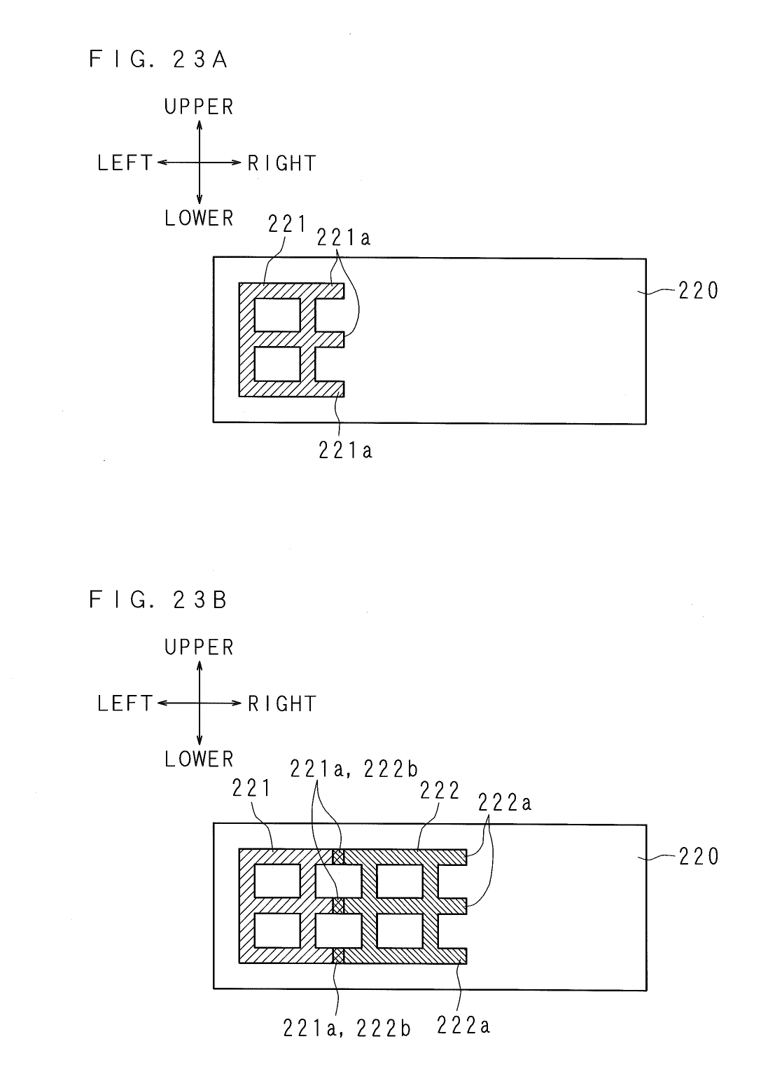

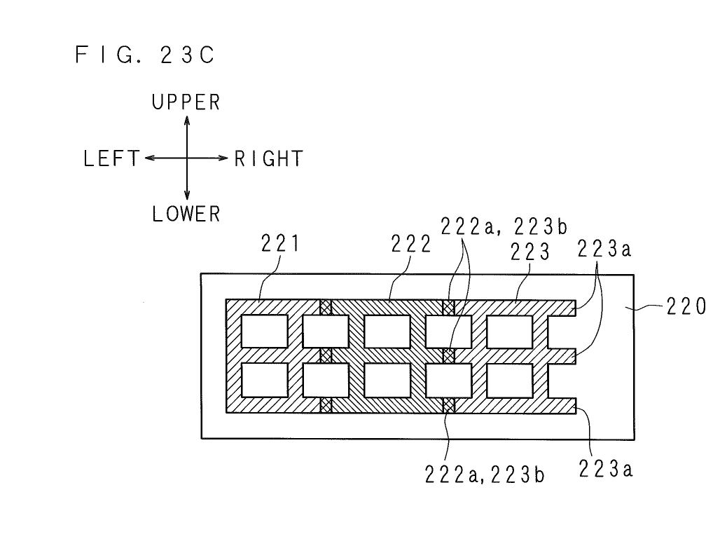

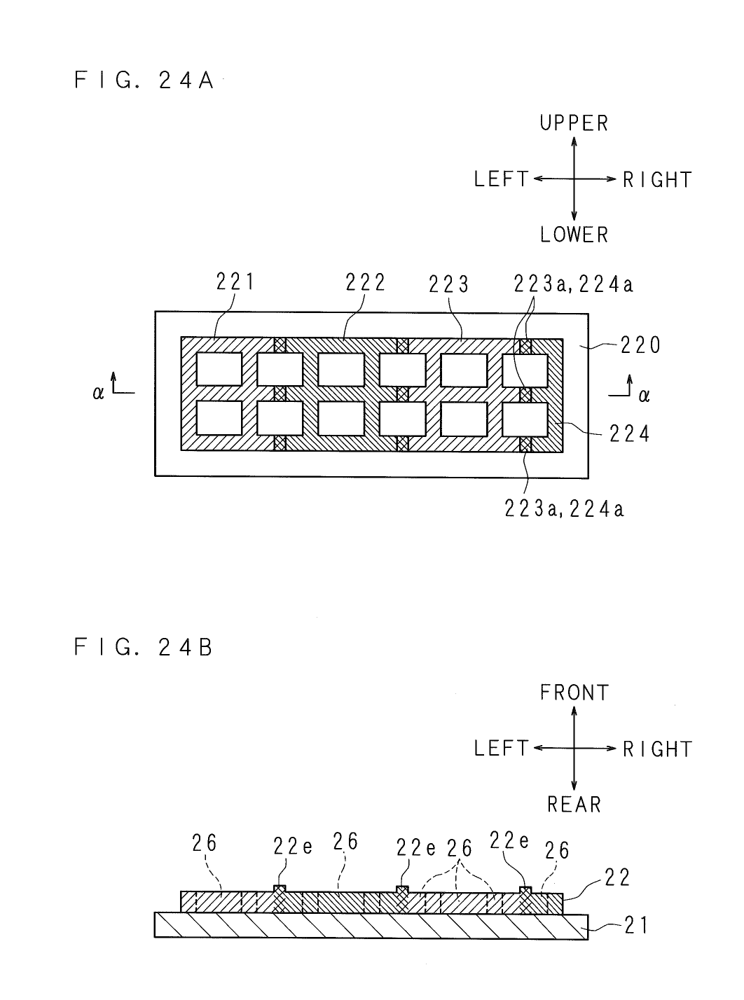

FIGS. 23A to 23C and FIGS. 24A and 24B are schematic views for describing the forming procedure of the BM 22. FIGS. 23A to 23C and FIG. 24A are front views, and FIG. 24 B is a cross-sectional view taken on line α-α of FIG. 24A. In FIGS. 23A to 23C and FIGS. 24A and 24B, the exposed portions are illustrated by hatching, and the twice exposed portions are illustrated by cross hatching. FIGS. 23A to 23C and FIGS. 24A and 24B correspond to FIGS. 5A to 5C and FIGS. 6A and 6B of Embodiment 1.

The exposure is performed on the left end part of the light shielding material layer 220 through the left side mask part 431 by the manufacture (see FIG. 23A). The exposed portion at this time is referred to as an exposure frame 221 below. The shape of the exposure frame 221 is equal to the shape of the mask pattern of the left side mask part 431. The right end parts 221a, 221a, and . . . of the exposure frame 221 are tip parts of the extension portion of the respective upper, middle, and lower frames according to the above-described 8-shaped frame.

Then, the exposure is performed on the left half of the horizontal central part of the light shielding material layer 220 through the central mask part 432 by the manufacture (see FIG. 23B). The newly exposed portion at this time is referred to as an exposure frame 222 below. The shape of the exposure frame 222 and an exposure frame 223 to be described below is equal to the shape of the mask pattern of the central mask part 432. The right end parts 222a, 222a, and . . . of the exposure frame 222 are the tip parts of the extension portion to the right side of the respective upper, middle, and lower frames according to the above-described 8-shaped frame. The left end parts 222b, 222b, and . . . of the exposure frame 222 are the tip parts of the extension portion to the left side of the respective upper, middle, and lower frames according to the above-described 8-shaped frame. The exposure frame 222 is provided so that the arrangement position of the left end parts 222b, 222b, and . . . of the exposure frame 222 is consistent with the arrangement position of the right end parts 221a, 221a, and . . . of the exposure frame 221. Briefly, the right end parts 221a, 221a, and . . . of the exposure frame 221 are exposed again.

By compensating the right end parts 221a, 221a, and . . . , and the vicinity of the right end parts 221a, 221a of the exposure frame 221, and . . . , and the left end parts 222b, 222b, and . . . , and the vicinity of the left end parts 222b, 222b, and . . . of the exposure frame 222 each other, an 8 frame-shaped exposure portion is generated. When developing the 8 frame-shaped exposure portion, two openings 26 and 26 adjacent to each other in the vertical direction are generated. Light shielding convex parts 22e, 22e, and . . . to be described below are generated in the peripheral edge parts of the openings 26 and 26.

Further, the exposure is performed on the right half of the horizontal central part of the light shielding material layer 220 through the central mask part 432 by the manufacture (see FIG. 23C). The newly exposed portion at this time is referred to as an exposure frame 223 below. The exposure frame 223 is provided so that the arrangement position of the left end parts 223b, 223b, and . . . of the exposure frame 223 is consistent with the arrangement position of the right end parts 222a, 222a, and . . . of the exposure frame 222. Briefly, the right end parts 222a, 222a, and . . . of the exposure frame 222 are exposed again.

By compensating the right end parts 222a, 222a, and . . . of the exposure frame 222, and the vicinity of the right end parts 222a, 222a, and . . . , and the left end parts 223b, 223b, and . . . of the exposure frame 223, and the vicinity of the left end parts 223b, 223b, and . . . each other, the 8 frame-shaped exposure portion is generated. When developing the 8 frame-shaped exposure portion, two openings 26 and 26 adjacent to each other in the vertical direction are generated. The light shielding convex parts 22e, 22e, and . . . are generated in the peripheral edge parts of the openings 26 and 26.

Further, the exposure is performed on the right end part of the light shielding material layer 220 through the right side mask part 433 by the manufacture (see FIG. 24A). The exposed portion at this time is referred to as an exposure frame 224 below. The shape of the exposure frame 224 is equal to the shape of the mask pattern of the right side mask part 433. The exposure frame 224 is provided so that the arrangement position of the left end parts 224a, 224a, and . . . of the exposure frame 224 is consistent with the arrangement position of the right end parts 223a, 223a, and . . . of the exposure frame 223. Briefly, the right end parts 223a, 223a, and . . . of the exposure frame 223 are exposed again.

By compensating the right end parts 223a, 223a, and . . . of the exposure frame 223, and the vicinity of the right end parts 223a, 223a, and . . . , and the left end parts 224a, 224a, and . . . of the exposure frame 224, and the vicinity of the left end parts 224a, 224a, and . . . each other, the 8 frame-shaped exposure portion is generated. When developing the 8 frame-shaped exposure portion, two openings 26 and 26 adjacent to each other in the vertical direction are generated. The light shielding convex parts 22e, 22e, and . . . are generated in the peripheral edge parts of the openings 26 and 26.

Thereafter, when removing the unexposed portion of the light shielding material layer 220 with the developing solution, the BM 22 in which the openings 26, 26, and . . . are arranged in parallel is obtained (see FIG. 24B).

When forming the BM 22, the alignment marks M1 to M4 also simultaneously formed. At this time, the respective alignment marks M1 to M4 are formed at the frame region.

Herein, as illustrated in FIG. 24B, the BM 22 has the light shielding convex parts 22e, 22e, and . . . . The light shielding convex parts 22e, 22e, and . . . correspond to the portion on which the light shielding material layer 220 was twice exposed, and protrude from the only once exposed portion. The protrusion position of each light shielding convex part 22e is a portion corresponding to the horizontal central part of the opening 26 in the BM 22. That is, the horizontal position according to the light shielding convex part 22e is consistent with the horizontal position according to the horizontal central part of the opening 26. Each light shielding convex part 22e is a part of the BM 22.

In the present embodiment, the light shielding convex part 22e is disposed at the position corresponding to the horizontal central position of the opening 26, but the horizontal central part of the opening 26 is not limited to the horizontal central position of the opening 26.

Herein, advantageous points of the BM 22 of the present embodiment will be described as compared with the BM 22 patterned by the procedure as in the prior art.

As can be seen by referring to FIG. 6B, in the case of the BM 22 patterned by the procedure as in the prior art, the horizontal width of the vertical BM is not constant. The reason is that, for example, when the exposure frame 22b is formed by causing the positional shift to the horizontal direction, with respect to the exposure frame 22a formed at the correct position, the horizontal arrangement position according to the right frame of the exposure frame 22a is not consistent with the horizontal arrangement position according to the left frame of the exposure frame 22b, such that the second vertical BM from the left side illustrated in FIG. 6B becomes wider than the other vertical BM.

Meanwhile, as can be seen by referring to FIG. 24B, in the case of the BM 22 patterned by the procedure of the present embodiment, the horizontal width of the vertical BM is constant. For example, even when the exposure frame 222 is formed by causing the positional shift to the horizontal direction, with respect to the exposure frame 221 which is formed at the correct position, the horizontal width of the vertical BM is not affected. Only a range in which the right end parts 221a, 221a, and . . . of the exposure frame 221 and the left end parts 222b, 222b, and . . . of the exposure frame 222 are overlapped with each other is changed. As a result, the horizontal width of the second openings 26 and 26 from the left side is shortened (or increased), but if the exposure frame 223 is formed at the correct position, the horizontal width of the fourth openings 26 and 26 from the left side is increased (or shortened). From the above result, when seeing the whole of the display region of the liquid crystal display apparatus 1, unnecessarily decreasing of the aperture ratio of the BM 22 may not occur.

The color filter 2 as described above may have a shorter vertical BM than the conventional color filter by the same function and effect as Embodiments 1 and 2. Further, a problem that the vertical BM unnecessarily becomes wider by the positional shift during forming the BM 22 may be suppressed.

Furthermore, the color filter 2 of the present embodiment has the light shielding convex part 22e, but it is not limited thereto. For example, the color filter 2 may have a concaved step part instead of the light shielding convex part 22e. Otherwise, the color filter 2 may have a configuration in which the color tinge between the portion twice exposed by referring to two alignment marks and the portion once exposed by referring to one alignment mark in the BM 22 is different from each other, but there is no a step between these portions.

### Embodiment 4

A liquid crystal display apparatus 1 and a color filter 2 of the present embodiment have substantially the same configuration as the liquid crystal display apparatus 1 and the color filter 2 of Embodiments 1 to 3. Hereinafter, a difference from Embodiments 1 to 3 will be described, and the other parts corresponding to Embodiments 1 to 3 will be denoted by the same reference numerals, and will not be described.

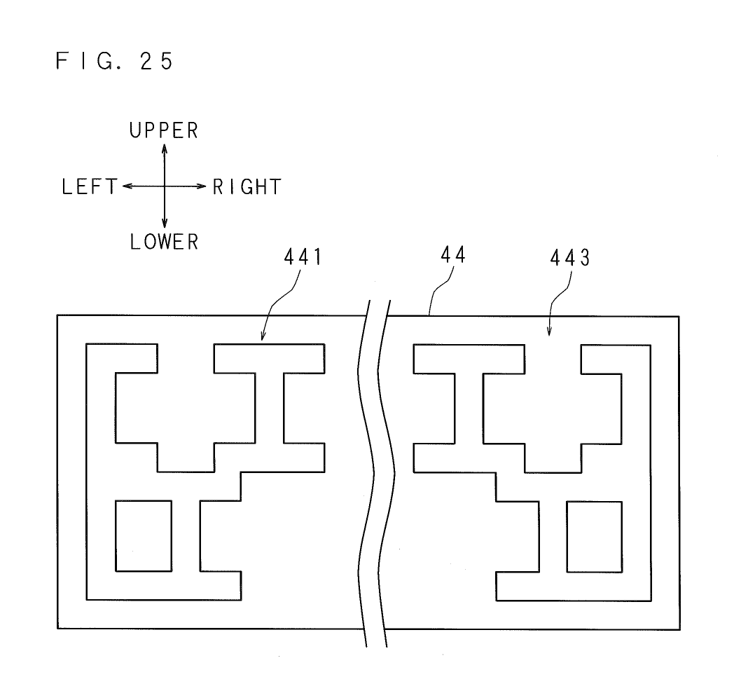

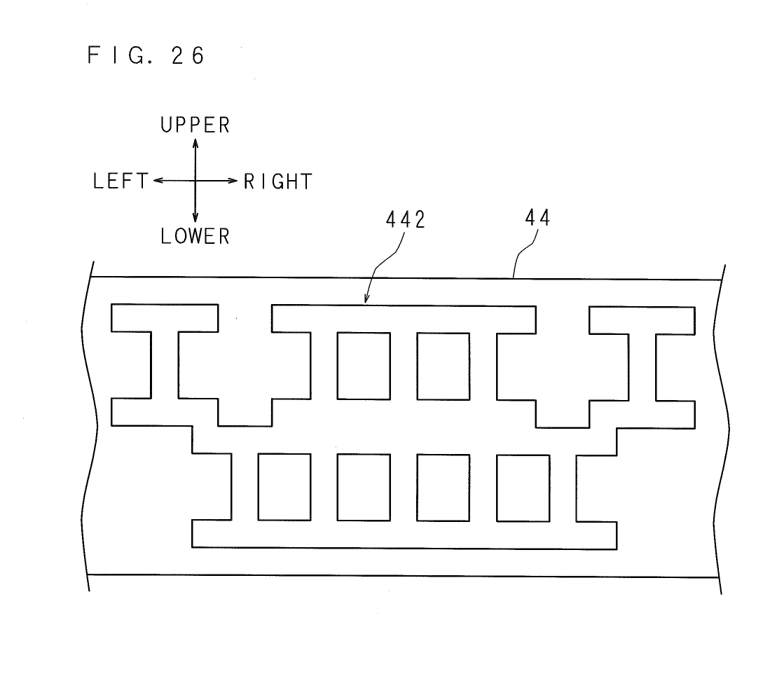

FIGS. 25 and 26 are front views schematically illustrating the configuration of an exposure mask 44 for patterning the BM 22 included in the color filter 2 according to Embodiment 4 of the present invention. FIGS. 25 and 26 correspond to FIG. 22 of Embodiment 3.

The exposure mask 44 of the present embodiment has a left side mask part 441, a central mask part 442, and a right side mask part 443. The left side mask part 441 and the right side mask part 443 are illustrated in FIG. 25, and the central mask part 442 is illustrated in FIG. 26.

The left side mask part 441, the central mask part 442, and the right side mask part 443 of the exposure mask 44 correspond to the left side mask part 431, the central mask part 432, and the right side mask part 433 of the exposure mask 43 of Embodiment 3.

Therefore, by using the left side mask part 441 of the exposure mask 44 once, the central mask part 442 twice, and the right side mask part 443 once, when performing the patterning by substantially the same procedure as the procedure of Embodiment 3, the BM 22 is obtained.

Herein, the BM 22 formed by the procedure of Embodiment 3 using the exposure mask 43 of Embodiment 3 is provided with twelve openings 26, 26, and . . . arranged two in the vertical direction and six in the horizontal direction, but the BM 22 formed by substantially the same procedure as Embodiment 3 using the exposure mask 44 of the present embodiment is provided with a total of sixteen openings 26, 26, and . . . arranged two in the vertical direction and eight in the horizontal direction

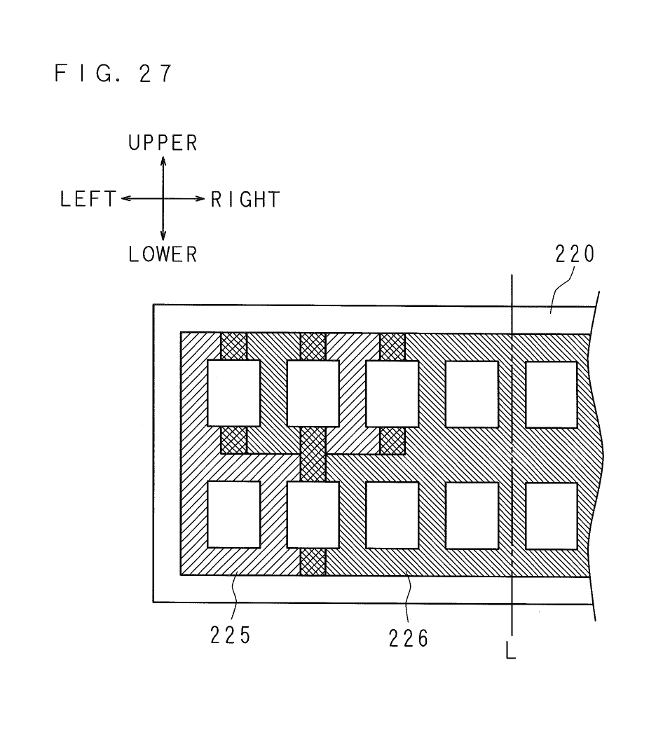

FIG. 27 is a schematic view for describing the forming procedure of the BM 22. FIG. 27 is a front view corresponding to FIG. 24A. In FIG. 27, the exposed portions are illustrated by hatching, and the twice exposed portions are illustrated by cross hatching.

The light shielding material layer 220 illustrated in FIG. 27 is provided with exposure frames 225 and 226 corresponding to the exposure frames 221 and 222 of Embodiment 3, and two exposure frames (not illustrated) corresponding to the exposure frames 223 and 224 of Embodiment 3. An exposure frame group is formed in a line-symmetrical shape taking an imaginary line L illustrated in FIG. 27 as an axis of symmetry.

By compensating the exposure frames 225 and 226 each other, frame-shaped exposure portions corresponding to the plurality of openings 26, 26, and . . . are generated. The exposure portions are provided with the twice exposed portions, and they become the light shielding convex parts 22e, 22e, and . . . . Also in the present embodiment, the protrusion position of each light shielding convex part 22e is a position corresponding to the horizontal central part of the opening 26.

Herein, advantageous points of the BM 22 of the present embodiment will be described as compared with the BM 22 of Embodiment 3.

As can be seen by referring to FIG. 24B, when the exposure frame 222 is formed by causing the positional shift to the left direction, with respect to the exposure frames 221 and 223 which are formed at the correct position, both of upper and lower horizontal widths of a second rectangular frame portion from the left side are shortened, but both of upper and lower horizontal widths of a fourth rectangular frame portion from the left side are increased.

Accordingly, in the openings 26, 26, and . . . corresponding to these portions, the horizontal width of both two openings adjacent to each other in the vertical direction is either shortened or increased. As a result, narrow openings 26, 26, and . . . are concentrated at a portion of the display region of the liquid crystal display apparatus 1, and wide openings 26, 26, and . . . are concentrated at the other portions thereof. Such a deviation may apply an adverse effect to the display of the color image.

Meanwhile, as can be seen by referring to FIG. 27, when the exposure frame 226 is formed by causing the positional shift to the horizontal direction, with respect to the exposure frame 225 which is formed at the correct position, the horizontal width of the rectangular frame portion on an upper first left side is shortened, but the horizontal width of the rectangular frame portion on a lower first left side is not changed. In addition, the horizontal width of a third rectangular frame portion from the upper left side is increased, but the horizontal width of the third rectangular frame portion from the lower left side is constant. Further, the horizontal width of the second rectangular frame portion from the upper left side is increased, but the horizontal width of the second rectangular frame portion from the lower left side is shortened.

Accordingly, in the openings 26, 26, and . . . corresponding to these portions, the horizontal width of both two openings adjacent to each other in the vertical direction is not shortened or increased. As a result, there are no narrow openings 26, 26, and . . . , or wide openings 26, 26, and . . . concentrated at the portion of the display region of the liquid crystal display apparatus 1. In other words, there is no deviation in the arrangement of the openings 26, 26, and . . . having different horizontal widths. Therefore, it is difficult to apply an adverse effect to the display of the color image.

In this regard, the BM 22 of Embodiment 3 is suitable for, in particular, the liquid crystal display apparatus 1 capable of having a sufficiently long vertical length of the BM 22 (that is, the horizontal BM) between the two openings 26 and 26 adjacent to each other in the vertical direction. As such the liquid crystal display apparatus 1, the liquid crystal display apparatus 1 of a so-called multi-pixel array may be considered. In the case of the multi-pixel array, one pixel of the color image consists of, for example, an upper sub-pixel and a lower sub-pixel. Further, each sub-pixel corresponds to three openings 26r, 26g, and 26b arranged in the horizontal direction. The horizontal BM having a sufficient long length is provided between the openings 26r, 26g, and 26b according to the upper sub-pixel and the openings 26r, 26g, and 26b according to the lower sub-pixel.

### Embodiment 5

A liquid crystal display apparatus 1 and a color filter 2 of the present embodiment have substantially the same configuration as the liquid crystal display apparatus 1 and the color filter 2 of Embodiments 1 to 4. Hereinafter, a difference from Embodiments 1 to 4 will be described, and the other parts corresponding to Embodiments 1 to 4 will be denoted by the same reference numerals, and will not be described.

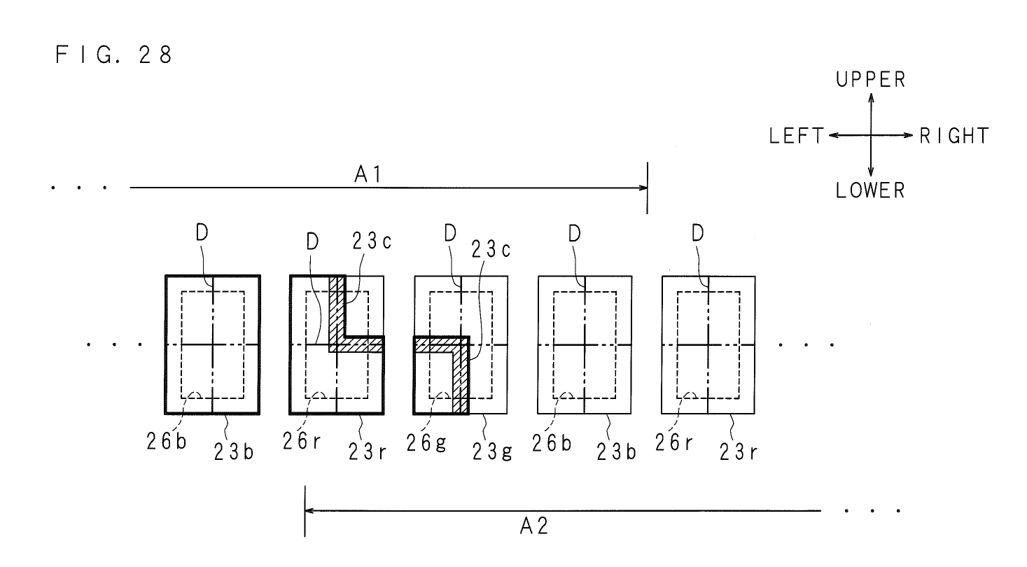

FIG. 28 is a front view schematically illustrating a configuration of the color filter 2 according to Embodiment 5 of the present invention. FIG. 28 corresponds to FIG. 2 of Embodiment 1 and FIG. 21 of Embodiment 2. Herein, among the openings 26, 26, and . . . illustrated in FIG. 2, an opening 26b included in the openings 26, 26, and . . . of one pixel on the upper left end part, and four openings 26r, 26g, 26b, and 26r arranged on the right side of the opening 26b are extracted in FIG. 28.

Among the openings 26, 26, and . . . illustrated in FIG. 28, the four openings on the left side are included in the range illustrated by the arrow A1, and four openings on the right side are included in the range illustrated by the arrow A2 in FIG. 3 of Embodiment 1.

The hatched portion in FIG. 28 is a colored convex part 23c. The colored convex part 23c corresponds to the colored convex part 23a of Embodiment 1, but the colored convex part 23a is formed in an I shape, whereas the colored convex part 23c is formed in an L shape. In the present embodiment, among the openings 26, 26, and . . . illustrated in FIG. 28, a second opening 26r and a third opening 26g from the left side (among the openings 26, 26, and . . . illustrated in FIG. 2, a fourth opening 26r and a fifth opening 26g from the left side) have the colored convex parts 23c and 23c.

The colored convex part 23c of the R layer 23r is formed, at the horizontal central part of the R layer 23r, in a bent line shape reaching a vertical central part from an upper end part, and reaching a right end part from the central part. The colored convex part 23c of the G layer 23g is formed, at the horizontal central part of the G layer 23g, in a bent line shape reaching the vertical central part from a lower end part, and reaching a left end part from the central part.

Preferably, the colored convex part 23c is disposed so as to be located upward of the crossing line D (see Embodiment 2), but it is not limited thereto.

For the R layer 23r having the colored convex part 23c, the portion which is exposed while referring to the alignment mark M1 is formed in a rectangular shape wherein a square section of an upper right corner is missing. This portion covers the upper left, lower left, and lower right three of four equally divided parts of the opening 26r on the top, bottom, left and right regions. In addition, for the R layer 23r, the portion which is exposed while referring to the alignment mark M2 is formed in a rectangular shape. This portion covers the upper right one of the four equally divided parts of the opening 26r on the top, bottom, left and right regions.

Meanwhile, for the G layer 23g, the portion which is exposed while referring to the alignment mark M1 is formed in the rectangular shape. This portion covers the lower left one of four equally divided parts of the opening 26g on the top, bottom, left and right regions. For the G layer 23g, the portion which is exposed while referring to the alignment mark M2 is formed in the rectangular shape. This portion covers the upper right, lower right, and upper left three of the four equally divided parts of the opening 26g on the top, bottom, left and right regions.

For the R layer 23r and the G layer 23g which have the colored convex part 23c, the portions facing each other are formed by exposing with reference to the same alignment marks M1 to M4.

Briefly, in also the present embodiment, the unnecessarily close arrangement or separated arrangement of the RGB layers 23 and 23 caused by referring to the different alignment marks M1 to M4 does not occur.

Herein, the color filter 2 of the present embodiment is compared with the color filter of Embodiment 1.

In Embodiment 1, as illustrated in FIG. 2, three R layer 23r, G layer 23g, and B layer 23b adjacent to each other have the colored convex parts 23a, 23a, and . . . .

Meanwhile, in the present embodiment, two R layer 23r and G layer 23g adjacent to each other have the colored convex parts 23c and 23c.

In addition, for the vertical direction, the colored convex part 23c is shorter than the colored convex part 23a. The colored convex part 23c has a portion disposed in the horizontal direction as much as the shortened length.

Briefly, in Embodiment 1, an effect of the colored convex part 23a is concentrated in the vertical direction, but in Embodiment 5, the effect of the colored convex part 23c is dispersed in the vertical direction and the horizontal direction.

From the above description, it can be said that the effect to the display of the color image caused by the colored convex part 23a or the colored convex part 23c is smaller in the color filter 2 of the present embodiment than the above-described embodiments.

### Embodiment 6

A liquid crystal display apparatus 1 and a color filter 2 of the present embodiment have substantially the same configuration as the liquid crystal display apparatus 1 and the color filter 2 of Embodiments 1 to 5. Hereinafter, a difference from Embodiments 1 to 5 will be described, and the other parts corresponding to Embodiments 1 to 5 will be denoted by the same reference numerals, and will not be described.

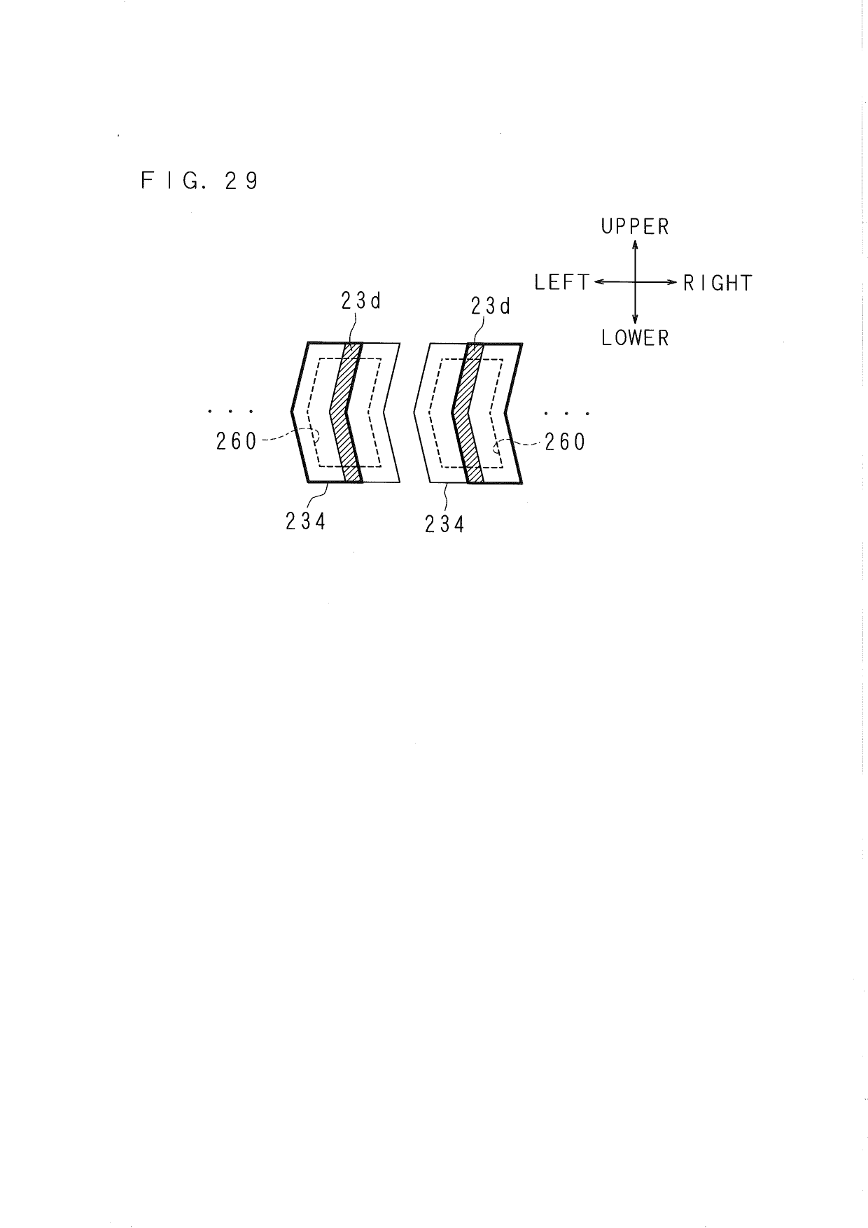

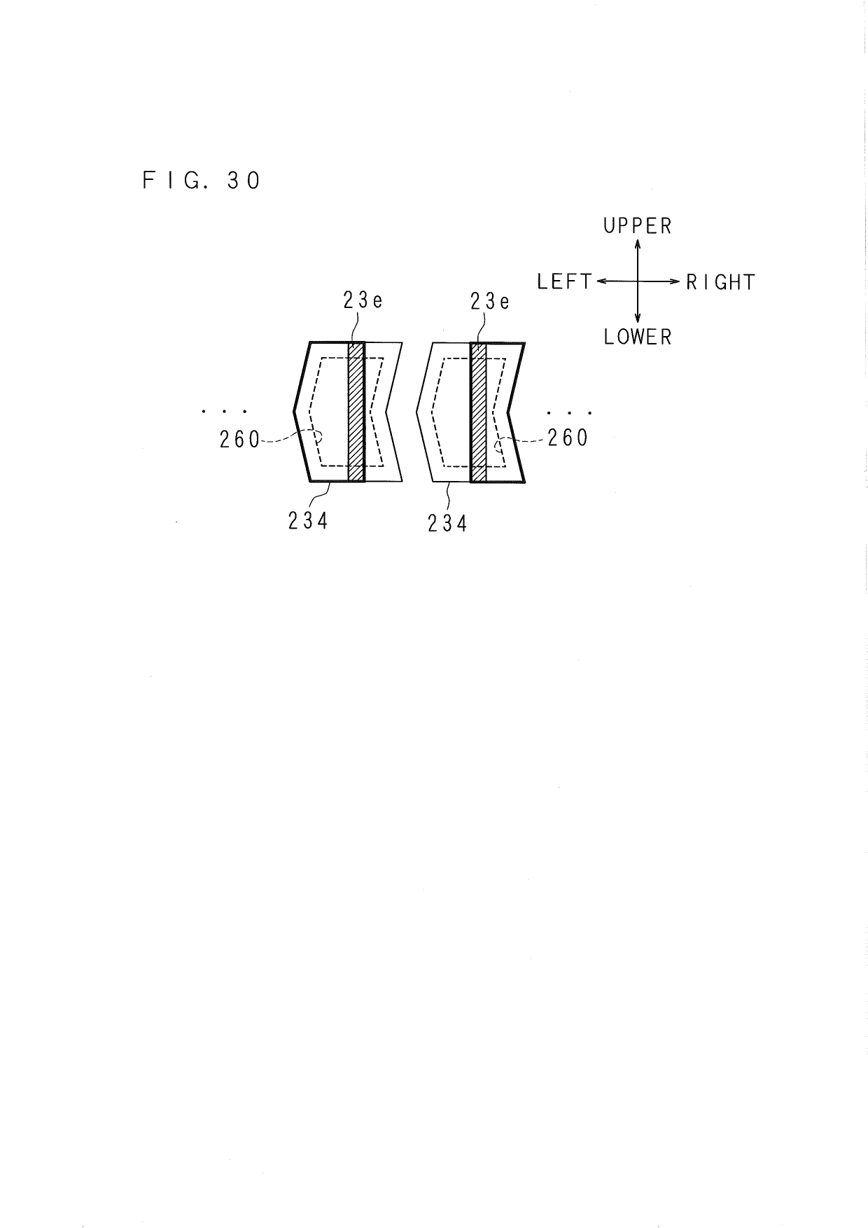

FIGS. 29 and 30 are front views schematically illustrating the configuration of an RGB layer 234 included in the color filter 2 according to Embodiment 6 of the present invention. FIGS. 29 and 30 correspond to FIG. 2 of Embodiment 1.

In the present embodiment, the BM 22 includes openings 260, 260, and . . . which are not rectangular shaped and arranged in parallel. Each opening 260 is formed in a hexagonal shape which is bent in the dogleg shape. Therefore, the RGB layer 234 disposed in the opening 260 is also formed in the hexagonal shape.

A colored convex part 23d included in the RGB layer 234 illustrated in FIG. 29 is formed in the dogleg shape. Briefly, the colored convex part 23d is formed, at the horizontal central part of the RGB layer 234, in a line shape along the peripheral edge part of the opening 260 over the both vertical end parts.

Meanwhile, a colored convex part 23e included in the RGB layer 234 illustrated in FIG. 30 is formed in an I shape. Briefly, the colored convex part 23e is formed, at the horizontal central part of the RGB layer 234, in a straight line shape over the both vertical end parts.

As the colored convex part to be included in the RGB layer 234 is either the colored convex part 23d or the colored convex part 23e, it is possible to obtain the same function and effect as Embodiment 1.

As it can be seen from Embodiments 1, 5 and 6, the shape of the colored convex part may be relatively freely determined, regardless of the shape of the opening and the respective RGB layers. Specifically, the shape of the colored convex part may be determined depending on, for example, ease of manufacturing of the exposure mask for patterning the RGB layer, the effect to the display of the color image, or the arrangement position of the blockage part.

### Embodiment 7

A liquid crystal display apparatus 1 and a color filter 2 of the present embodiment have substantially the same configuration as the liquid crystal display apparatus 1 and the color filter 2 of Embodiments 1 to 6. Hereinafter, a difference from Embodiments 1 to 6 will be described, and the other parts corresponding to Embodiments 1 to 6 will be denoted by the same reference numerals, and will not be described.

The liquid crystal display apparatus 1 of Embodiments 1 to 6 displays the color image by an RGB system, a liquid crystal display apparatus 1 of the present embodiment displays the color image by an RGBW system. In the RGBW system, four openings 26, 26, and . . . arranged in a cross in square frame shape in the vertical direction and the horizontal direction correspond to one pixel of the color image. Hereinafter, a white colored layer is referred to as a W layer 23w.

For the four openings 26, 26, and . . . of one pixel, the horizontal width of the vertical BM between the openings 26 and 26 adjacent to each other in the horizontal direction, and the vertical length of the horizontal BM between the openings 26 and 26 adjacent to each other in the vertical direction are different from each other.

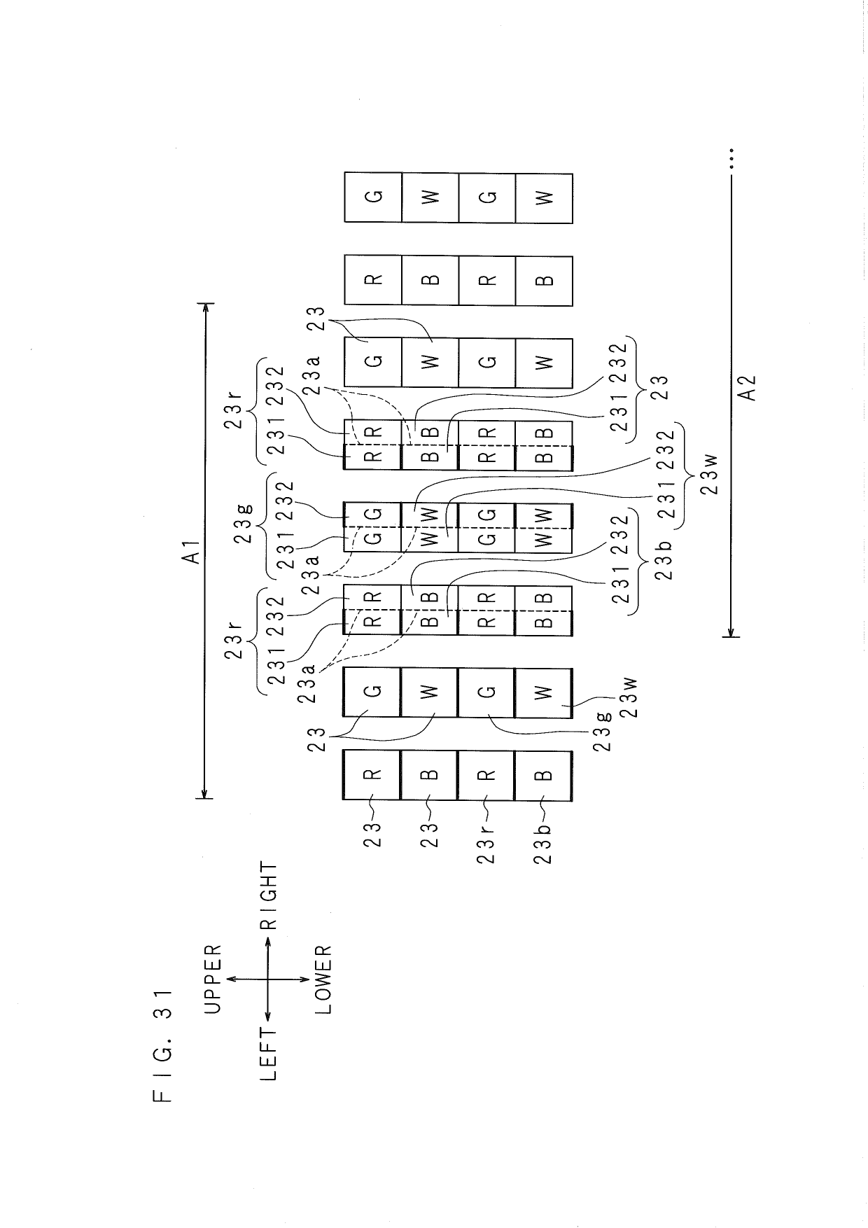

FIG. 31 is a front view schematically illustrating the configuration of the color filter 2 according to Embodiment 7 of the present invention. In the color filter 2 illustrated in FIG. 31, the horizontal width of the vertical BM is longer than the vertical length of the horizontal BM.

FIG. 31 corresponds to FIG. 3 of Embodiment 1. Herein, FIG. 31 illustrates the RGB layers 23, 23, and . . . of four pixels in the horizontal direction, and two pixels in the vertical direction. In addition, the number of the horizontal pixels included in a portion in which a range illustrated by the arrow A1 and a range illustrated by the arrow A2 are overlapped with each other is one in Embodiment 1, but it is two in the present embodiment.

The color of each RGB layer 23 is illustrated by the alphabetical characters of ‘R’, ‘G’, ‘B’, and ‘W’. Herein, the color of the RGB layer 23 having the colored convex part 23a (furthermore the left exposure part 231 and the right exposure part 232) is illustrated by the alphabetical characters of ‘RR’, ‘GG’, ‘BB’, and ‘WW’.

Except that the R layer 23r, the G layer 23g, the B layer 23b, and the W layer 23w are disposed in the openings 26, 26, and . . . of one pixel, the manufacturing procedure of the color filter 2 illustrated in FIG. 31 is not much different from the manufacturing procedure of the color filter 2 of Embodiment 1.

Therefore, for the two RGB layers 23 and 23 adjacent to each other in the horizontal direction, at least the portions facing each other are formed by exposing with reference to the same alignment marks M1 to M4.

Accordingly, the color filter 2 of the present embodiment may also have a shorter vertical BM than the conventional color filter by the same function and effect as Embodiment 1.

### Embodiment 8

A liquid crystal display apparatus 1 and a color filter 2 of the present embodiment have substantially the same configuration as the liquid crystal display apparatus 1 and the color filter 2 of Embodiment 7. Hereinafter, a difference from Embodiment 7 will be described, and the other parts corresponding to Embodiment 7 will be denoted by the same reference numerals, and will not be described.

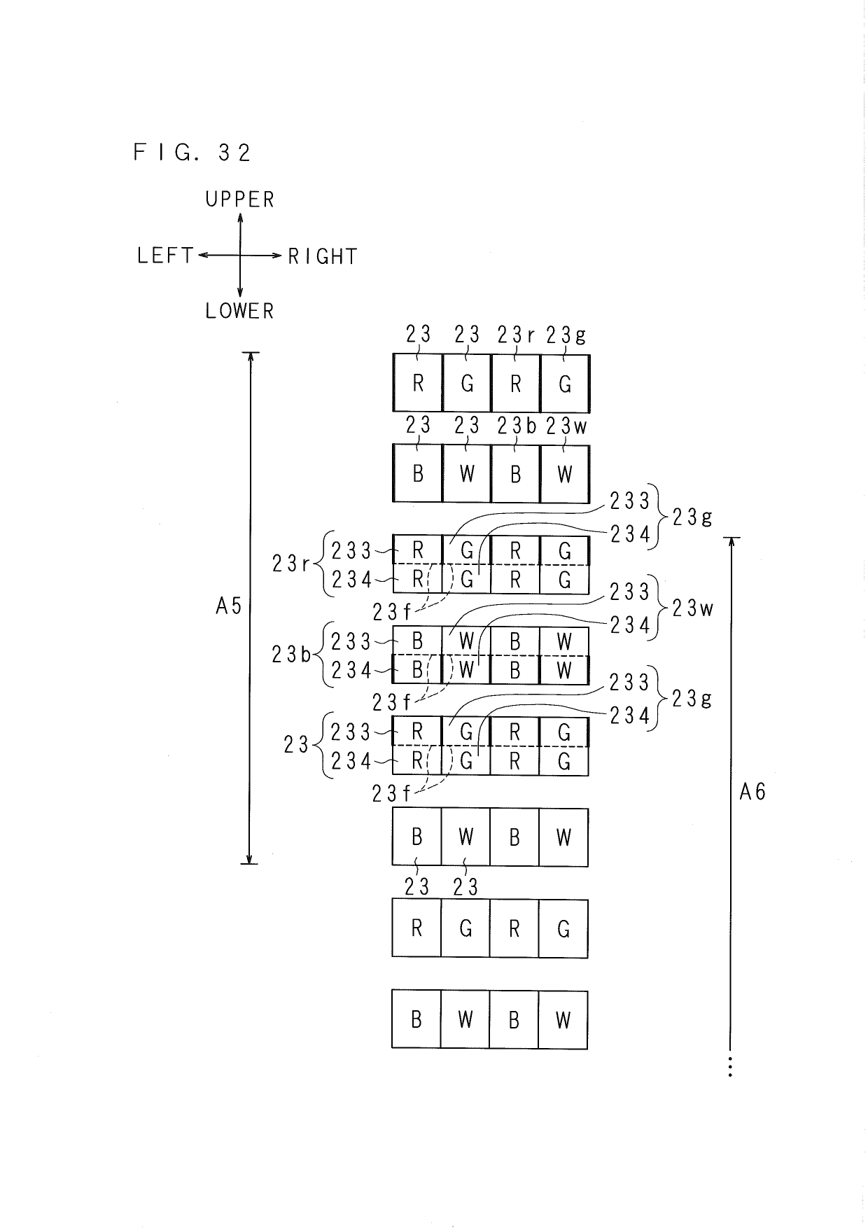

FIG. 32 is a front view schematically illustrating the configuration of the color filter 2 according to Embodiment 8 of the present invention. In the color filter 2 illustrated in FIG. 32, the vertical length of the horizontal BM is longer than the horizontal width of the vertical BM. FIG. 32 corresponds to FIG. 31 of Embodiment 7.

When manufacturing the color filter 2 of the present embodiment, during patterning the BM 22, four alignment marks (not illustrated, hereinafter referred to as alignment marks M5 to M8) different from the alignment marks M1 to M4 are provided in the BM 22.

In the case of the color filter 2 according to Embodiment 7, some of the RGB layers 23 may have, at the horizontal central part of the RGB layer 23, a straight-shaped colored convex part 23a over the both vertical end parts.

Meanwhile, in the case of the color filter 2 according to the present embodiment, some of the RGB layers 23 may have, at the vertical central part of the RGB layer 23, a straight-shaped colored convex part 23f over both horizontal end parts.

An upper half of the RGB layer 23 including the colored convex part 23f thereof is referred to as an upper exposure part 233 below. Also, a lower half of the RGB layer 23 including the colored convex part 23f thereof is referred to as a lower exposure part 234 below. The upper exposure part 233 and the lower exposure part 234 are portions formed by exposing with reference to the alignment marks M5 to M8 different from each other. The colored convex part 23f is a portion twice exposed by referring to two of the alignment marks M5 to M8.

FIG. 32 illustrates the RGB layer 23, the left exposure part 231, or the right exposure part 232 exposed by referring to the alignment mark M3 by a square having a vertical line of a thick solid line. Also, FIG. 32 illustrates the RGB layer 23, the left exposure part 231, or the right exposure part 232 exposed by referring to the alignment mark M4 by a square having a vertical line of a thin solid line.

As describe above, for the two RGB layers 23 and 23 adjacent to each other in the vertical direction, at least the portions facing each other are formed by exposing with reference to the same alignment marks M5 to M8.

A range illustrated by an arrow A5 in FIG. 32 is a range exposed through an upper mask part to be described below, with reference to the alignment mark M5.

A range illustrated by an arrow A6 is a range exposed through a middle mask part to be described below, with reference to the alignment mark M6.

Next, a forming procedure of the RGB layers 23, 23, and . . . will be described.

The exposure mask (not illustrated) is prepared for patterning RGB layers 23, 23, and . . . by the manufacture.

The exposure mask of the present embodiment has the upper mask part provided with the mask pattern of the RGB layers 23, 23, and . . . to be formed on the upper end part of the colored material layer 230, the middle mask part provided with the mask pattern of the RGB layers 23, 23, and . . . to be formed on the upper half or the lower half of the vertical central part of the colored material layer 230, and a lower mask part provided with the mask pattern of the RGB layers 23, 23, and . . . to be formed on the lower end part of the colored material layer 230.

The exposure is performed on the upper end part of the colored material layer 230 of one color through the upper mask part of the exposure mask for forming the RGB layers 23, 23, and . . . of one color, with reference to the alignment mark M5 by the manufacture.

Next, the exposure is performed on the upper half of the vertical central part of the colored material layer 230 through the middle mask part, with reference to the alignment mark M6 by the manufacture. At this time, the exposure is again performed on a part of the portion on which one previous exposure was performed.

Further, the exposure is performed on the lower half of the vertical central part of the colored material layer 230 through the middle mask part, with reference to the alignment mark M7 by the manufacture. At this time, the exposure is again performed on a part of the portion on which one previous exposure was performed.

Then, the exposure is performed on the lower end part of the colored material layer 230 through the lower mask part, with reference to the alignment mark M8 by the manufacture. At this time, the exposure is again performed on a part of the portion on which one previous exposure was performed.

The twice exposed portion is located at the vertical central part of the portion to form the RGB layer 23. That is, this portion is a portion in which the colored convex part 23f is generated.

Thereafter, when removing the unexposed portion of the colored material layer 230 with the developing solution, the RGB layers 23, 23, and . . . of one color are obtained.

The above-described procedure is performed on the RGB layers 23, 23, and . . . of red, green, blue, and white, respectively.

Therefore, for the two RGB layers 23 and 23 adjacent to each other in the vertical direction, at least the portions facing each other are formed by exposing with reference to the same alignment marks M5 to M8.

Accordingly, the color filter 2 of the present embodiment may also have a shorter horizontal width of the horizontal BM than the conventional color filter.

In this regard, even when the vertical length of the horizontal BM is longer than the horizontal width of the vertical BM as in the present embodiment, it is not impossible to perform the patterning of the RGB layers 23, 23, and . . . by the same procedure as Embodiment 7.

However, since the horizontal width of the vertical BM is short, in some cases, it is difficult to further shorten the same.

Meanwhile, since the horizontal BM has a longer vertical length, it is relatively easy to further shorten the same. Therefore, by shortening the vertical length of the horizontal BM to a greater extent than the conventional color filter, it is possible to efficiently improve the aperture ratio thereof.

Similarly, even when the vertical length of the horizontal BM is longer than the horizontal width of the vertical BM as in the present embodiment, it is not impossible to perform the patterning of the RGB layers 23, 23, and . . . by the same procedure as Embodiment 7. However, in these cases, since the horizontal width of the vertical BM is longer than the vertical length of the horizontal BM, by shortening the vertical length of the horizontal BM to a greater extent than the conventional color filter, it is possible to efficiently improve the aperture ratio thereof.

### Embodiment 9

A liquid crystal display apparatus 1 and a color filter 2 of the present embodiment have substantially the same configuration as the liquid crystal display apparatus 1 and the color filter 2 of Embodiments 1 to 6. Hereinafter, a difference from Embodiments 1 to 6 will be described, and the other parts corresponding to Embodiments 1 to 6 will be denoted by the same reference numerals, and will not be described.

The liquid crystal display apparatus 1 of the present embodiment is the liquid crystal display apparatus 1 with the multi-pixel array.

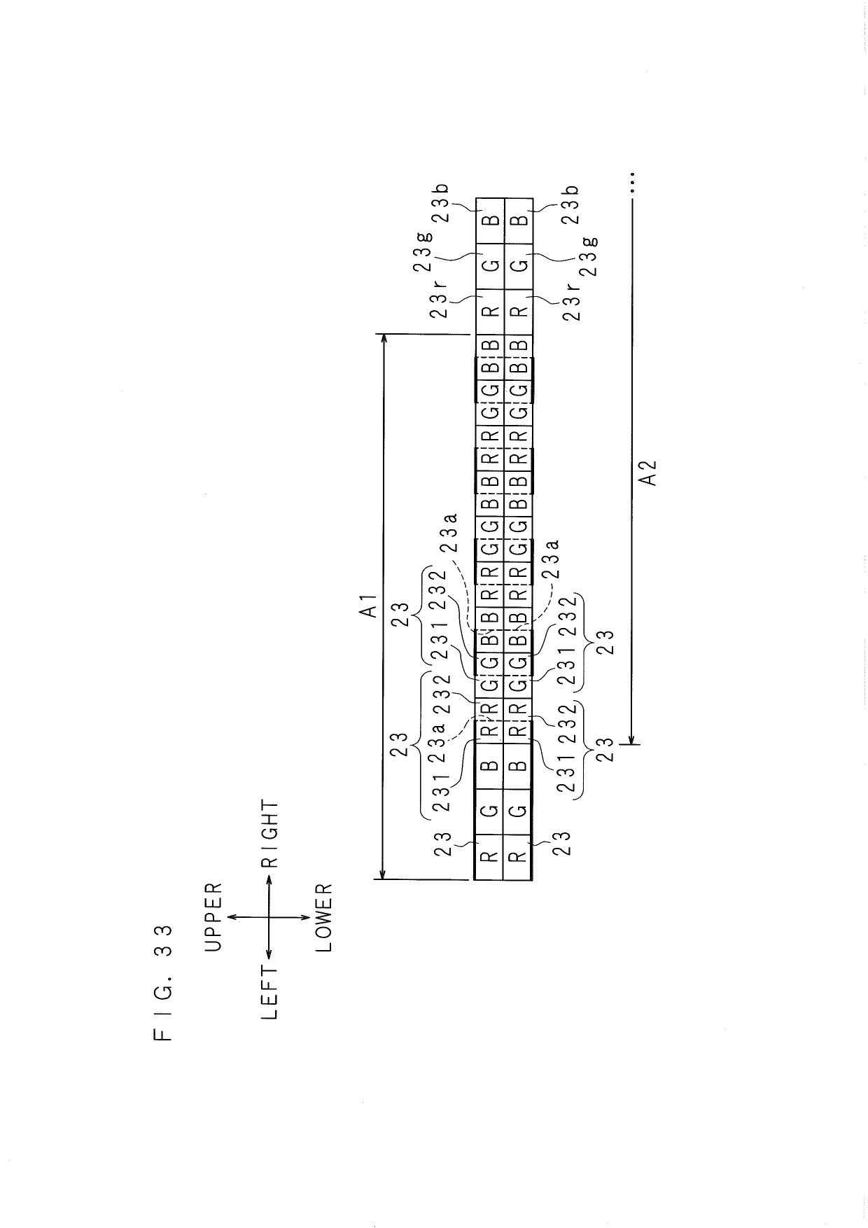

FIG. 33 is a front view schematically illustrating the configuration of the color filter 2 according to Embodiment 9 of the present invention. FIG. 33 corresponds to the FIG. 3 of Embodiment 1.

Herein, FIG. 33 illustrates the RGB layers 23, 23, and . . . of five horizontal pixels. The upper (or lower) three arranged R layer 23r, G layer 23g, and B layer 23b are the R layer 23r, the G layer 23g, and the B layer 23b corresponding to the upper (or lower) sub-pixels.

In addition, the number of the horizontal pixels included in a portion in which a range illustrated by the arrow A1 and a range illustrated by the arrow A2 are overlapped with each other is one in Embodiment 1, but it is three in the present embodiment.

The manufacturing procedure of the color filter 2 illustrated in FIG. 33 is not much different from the manufacturing procedure of the color filter 2 of Embodiment 1. The reason is that, the openings 26, 26, and . . . according to the upper sub-pixel illustrated in FIG. 33 may be considered to be the same openings as the openings 26, 26, and . . . according to the upper pixel illustrated in FIG. 3, and the openings 26, 26, and . . . according to the lower sub-pixel illustrated in FIG. 33 may be considered to be the same openings as the openings 26, 26, and . . . according to the lower pixel illustrated in FIG. 3

Therefore, the left exposure part 231 (or the right exposure part 232) according to the RGB layer 23 of an upper sub-pixel and the left exposure part 231 (or the right exposure part 232) according to the RGB layer 23 of a lower sub-pixel are formed by exposing with reference to the same alignment marks M1 to M4.

From the above result, for the two RGB layers 23 and 23 adjacent to each other in the horizontal direction, at least the portions facing each other are formed by exposing with reference to the same alignment marks M1 to M4. Accordingly, the color filter 2 of the present embodiment may also have a shorter vertical BM than the conventional color filter by the same function and effect as Embodiment 1.

### Embodiment 10

A liquid crystal display apparatus 1 and a color filter 2 of the present embodiment have substantially the same configuration as the liquid crystal display apparatus 1 and the color filter 2 of Embodiment 9. Hereinafter, a difference from Embodiment 9 will be described, and the other parts corresponding to Embodiment 9 will be denoted by the same reference numerals, and will not be described.

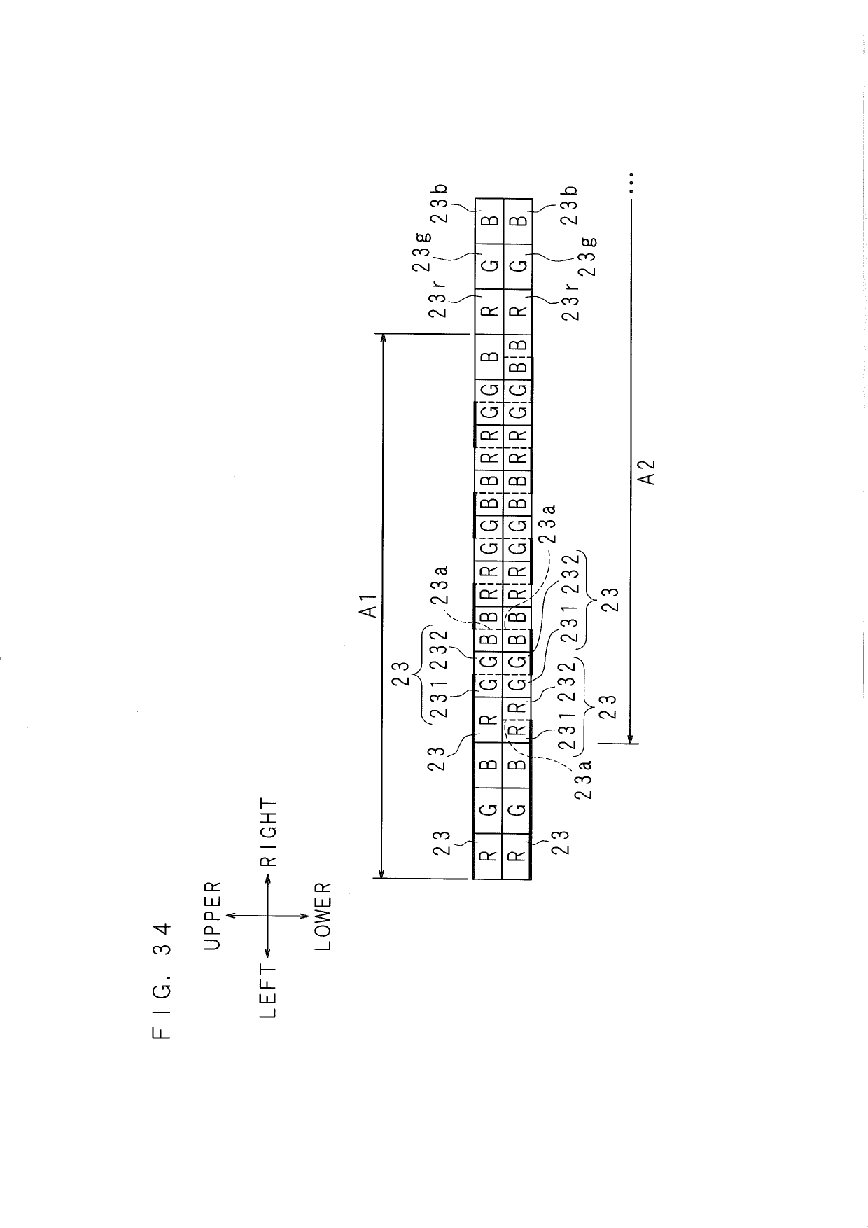

FIG. 34 is a front view schematically illustrating the configuration of the color filter 2 according to Embodiment 10 of the present invention.

The configuration of the lower sub-pixel group of the color filter 2 according to the present embodiment is the same as the configuration of the lower sub-pixel group of the color filter 2 according to Embodiment 9 (see FIG. 33).

Meanwhile, for the upper sub-pixel group of the color filter 2 according to the present embodiment, the number of the RGB layers 23 having the colored convex parts 23a is smaller than the upper sub-pixel group of the color filter 2 according to Embodiment 9.

The R layer 23r according to the lower sub-pixel of the second pixel from the left side has the colored convex part 23a, but the R layer 23r according to the upper sub-pixel of the R layer 23r does not have the colored convex part 23a.

Also, the B layer 23b according to the lower sub-pixel of the fourth pixel from the left side has the colored convex part 23a, but the B layer 23b according to the upper sub-pixel of the B layer 23b does not have the colored convex part 23a.

Seven RGB layers 23, 23, and . . . from the G layer 23g according to the upper sub-pixel of the second pixel from the left side to the G layer 23g according to the lower sub-pixel of the fourth pixel from the left side have the colored convex part 23a, respectively.

The left exposure part 231 according to the RGB layer 23 of the upper sub-pixel and the right exposure part 232 according to the RGB layer 23 of the lower sub-pixel are formed by exposing with reference to the same alignment marks M1 to M4. Meanwhile, the left exposure part 231 according to the RGB layer 23 of the upper sub-pixel and the left exposure part 231 according to the RGB layer 23 of the lower sub-pixel are formed by exposing with reference to the alignment marks M1 to M4 different from each other.

Similarly, the right exposure part 232 according to the RGB layer 23 of the upper sub-pixel and the left exposure part 231 according to the RGB layer 23 of the lower sub-pixel are formed by exposing with reference to the same alignment marks M1 to M4. Meanwhile, the right exposure part 232 according to the RGB layer 23 of the upper sub-pixel and the right exposure part 232 according to the RGB layer 23 of the lower sub-pixel are formed by exposing with reference to the alignment marks M1 to M4 different from each other.

However, the manufacturing procedure of the color filter 2 of the present embodiment is substantially the same manufacturing procedure as the color filter 2 according to Embodiment 9, except that the shape of the mask pattern provided in the exposure mask for forming the RGB layers 23, 23, and . . . is different from that of the mask pattern used when manufacturing the color filter 2 according to Embodiment 9.

From the above result, for the two RGB layers 23 and 23 adjacent to each other in the horizontal direction, at least the portions facing each other are formed by exposing with reference to the same alignment marks M1 to M4. Accordingly, the color filter 2 of the present embodiment may also have a shorter vertical BM than the conventional color filter by the same function and effect as Embodiment 1.

Herein, a comparison between the color filters 2 according to Embodiments 9 and 10 will be described in detail.

When the positional shift occurs during forming the RGB layers 23, 23, and . . . , and the wide (or thin) colored convex part 23a is generated in the RGB layer 23 according to the lower sub-pixel, in the color filter 2 according to the Embodiment 9, the wide (or thin) colored convex part 23a is also generated in the RGB layer 23 according to the upper sub-pixel. Meanwhile, in the color filter 2 according to Embodiment 10, even when the wide (or thin) colored convex part 23a is generated in the RGB layer 23 according to the lower sub-pixel, there is no colored convex part 23a in the RGB layer 23 according to the upper sub-pixel, or the thin (or wide) colored convex part 23a is generated.

Briefly, for the vertical direction, the wide colored convex part 23a is never continued. In other words, the wide colored convex parts 23a, 23a, and . . . are dispersedly arranged on the whole of the display region of the liquid crystal display apparatus 1. Accordingly, it is difficult to see the adverse effect applied to the display of the color image by the colored convex parts 23a, 23a, and

### Embodiment 11

A liquid crystal display apparatus 1 and a color filter 2 of the present embodiment have substantially the same configuration as the liquid crystal display apparatus 1 and the color filter 2 of Embodiments 9 and 10. Hereinafter, a difference from Embodiments 9 and 10 will be described, and the other parts corresponding to Embodiments 9 and 10 will be denoted by the same reference numerals, and will not be described.

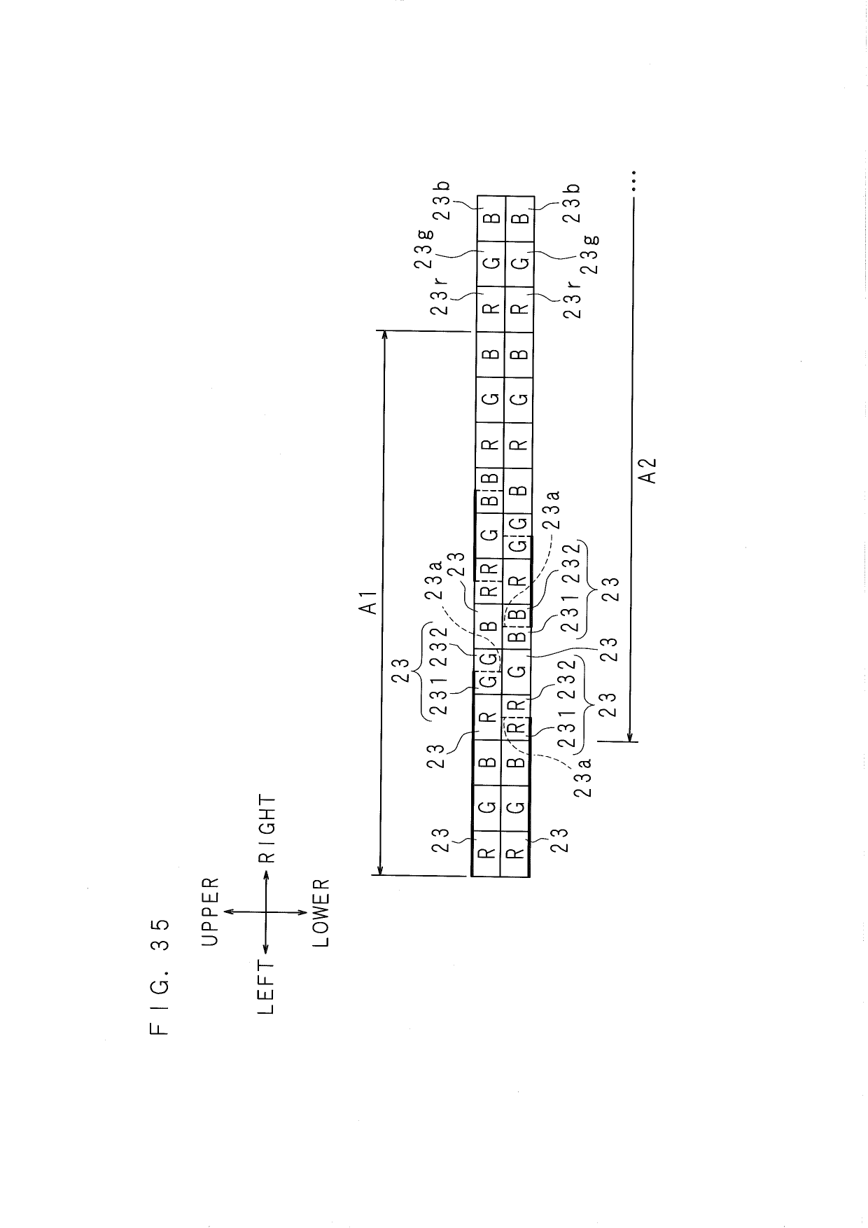

FIG. 35 is a front view schematically illustrating the configuration of the color filter 2 according to Embodiment 11 of the present invention.

If the RGB layer 23 according to the upper sub-pixel and the RGB layer 23 of the lower sub-pixel are considered to be one RGB layer 23, the color filter 2 according to the present embodiment has substantially the same construction as the color filter 2 according to Embodiment 5 (see FIG. 28).

When the RGB layer 23 according to the lower sub-pixel has the colored convex part 23a, the RGB layer 23 according to the upper sub-pixel of the RGB layer 23 does not have the colored convex part 23a. Similarly, when the RGB layer 23 according to the upper sub-pixel has the colored convex part 23a, the RGB layer 23 according to the lower sub-pixel of the RGB layer 23 does not have the colored convex part 23a.

The manufacturing procedure of the color filter 2 of the present embodiment is also substantially the same manufacturing procedure as the color filter 2 according to Embodiments 9 and 10, except that the shape of the mask pattern provided in the exposure mask for forming the RGB layers 23, 23, and . . . is different from that of the mask pattern used when manufacturing the color filter 2 according to Embodiments 9 and 10.

Therefore, for the two RGB layers 23 and 23 adjacent to each other in the horizontal direction, at least the portions facing each other are formed by exposing with reference to the same alignment marks M1 to M4. Accordingly, the color filter 2 of the present embodiment may also have a shorter vertical BM than the conventional color filter by the same function and effect as Embodiment 1.

Herein, a comparison among the color filters 2 according to Embodiments 9 to 11 will be described in detail.

In the case of the color filter 2 according to Embodiments 9 and 10, if the RGB layer 23 according to one of the upper and lower sub-pixels has the colored convex part 23a, the RGB layer 23 according to the other sub-pixel also has the colored convex part 23a excluding some exceptions.

However, in the color filter 2 according to Embodiment 11, only one of the upper and lower sub-pixels has the colored convex part 23a at most. Briefly, a total amount of the colored convex parts 23a, 23a, and . . . is small. Accordingly, the adverse effect applied to the display of the color image by the colored convex parts 23a, 23a, and . . . is small.

### Embodiment 12

A liquid crystal display apparatus 1 and a color filter 2 of the present embodiment have substantially the same configuration as the liquid crystal display apparatus 1 and the color filter 2 of Embodiments 1 to 6. Hereinafter, a difference from Embodiments 1 to 6 will be described, and the other parts corresponding to Embodiments 1 to 6 will be denoted by the same reference numerals, and will not be described.

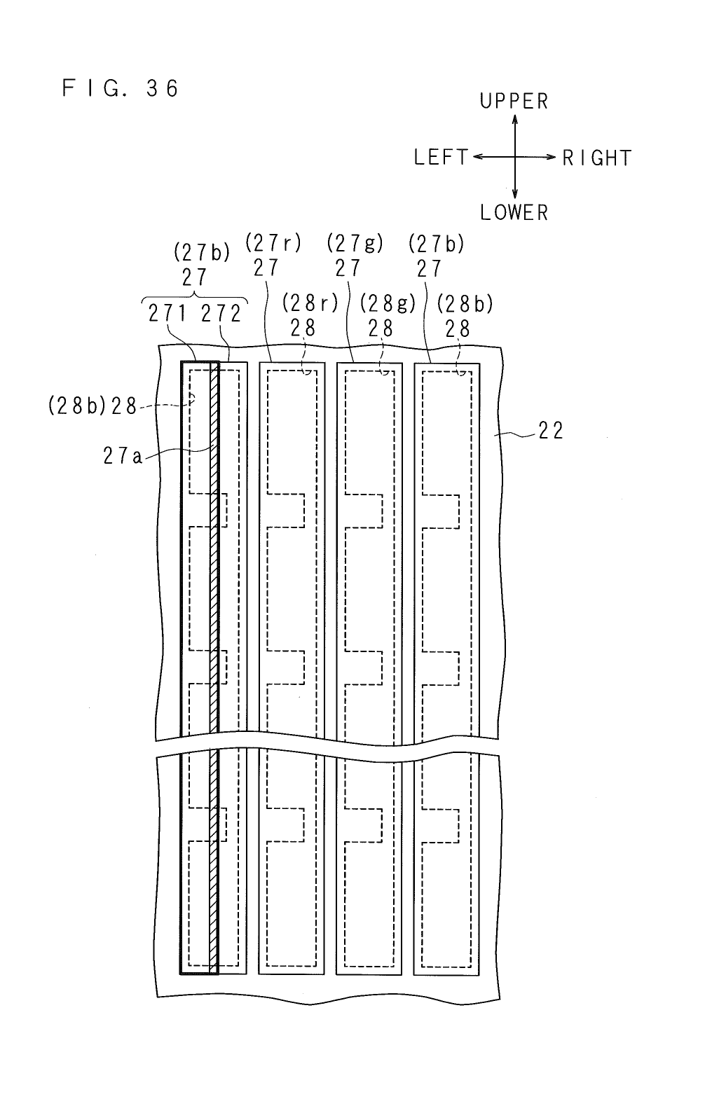

FIG. 36 is a front view schematically illustrating the configuration of the color filter 2 according to Embodiment 12 of the present invention. FIG. 36 corresponds to the FIG. 2 of Embodiment 1.

The color filter 2 of the present embodiment has RGB layers 27, 27, and . . . , and openings 28, 28, and . . . , instead of the RGB layers 23, 23, and . . . , and the openings 26, 26, and . . . of Embodiment 1.

The BM 22 of Embodiment 1 includes hundreds of openings 26, 26, and . . . arranged in parallel in the horizontal direction and the vertical direction, respectively. Each opening 26 is formed in a rectangular shape.

Meanwhile, the BM 22 of the present embodiment includes hundreds of openings 28, 28, and . . . arranged in parallel in the horizontal direction. Each opening 28 is formed in a shape as the openings 26, 26, and . . . arranged in parallel in the vertical direction in Embodiment 1 are connected to each other by removing the right end parts of the horizontal BMs between the openings 26, 26, and . . . .

Each RGB layer 27 is formed in a rectangular shape larger than the opening 28. One RGB layer 27 closes one opening 28. At this time, the RGB layer 27 is filled in the opening 28. In addition, the peripheral edge part of the RGB layer 27 is overlapped with at least the peripheral edge part of the opening 28 (that is, a part of the BM 22).

The openings 28, 28, and . . . illustrated in FIG. 36 correspond to four openings 26, 26, and . . . from the right side illustrated in FIG. 2. Similarly, the RGB layers 27, 27, and . . . illustrated in FIG. 36 correspond to four RGB layers 23, 23, and . . . from the right side illustrated in FIG. 2.

Accordingly, the RGB layer 27 of the left end part illustrated in FIG. 36 has a colored convex part 27a (a hatched portion in FIG. 36) corresponding to the colored convex part 23a of Embodiment 1. That is, the colored convex part 27a is a portion twice exposed by referring to two alignment marks.

In addition, a left half of the RGB layer 27 including the colored convex part 27a thereof is a left exposure part 271, and a right half of the RGB layer 27 including the colored convex part 27a thereof is a right exposure part 272. The left exposure part 271 and the right exposure part 272 are portions formed by exposing with reference to two alignment marks different from each other.

For the two RGB layers 27 and 27 adjacent to each other in the horizontal direction, at least the portions facing each other (for example, the right exposure part 272 of the RGB layer 27 on the left side and the left exposure part 271 of the RGB layer 27 on the right side) are formed by exposing with reference to the same alignment marks. Briefly, in also the present embodiment, the unnecessarily close arrangement or separated arrangement of the RGB layers 27 and 27 caused by referring to the different alignment marks does not occur.

Except the shape of the RGB layers 27, 27, and . . . , and the openings 28, 28, and . . . , the manufacturing procedure of the color filter 2 of the present embodiment is not much different from the manufacturing procedure of the color filter 2 of Embodiment 1.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

In addition, as long as having the effects of the present invention, components which are not disclosed in Embodiments 1 to 11 may be included in the liquid crystal display apparatus 1 or the color filter 2.

Components (technical characteristics) disclosed in each embodiment may be combined with each other, and by combining these components new technical characteristics may be formed.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

1-8. (canceled)

9. A color filter, comprising:
a transparent substrate;
a light shielding layer which is formed on one surface of the transparent substrate, and includes a plurality of openings arranged in parallel in one direction thereof; and
a colored layer which is disposed in each opening to close the opening, and is partially overlapped with the light shielding layer,
wherein the colored layers respectively disposed in the at least two openings have a colored convex part at a central part in the one direction.

10. The color filter according to claim 9, wherein
the light shielding layer has a light shielding convex part at a position corresponding to the central part in the one direction.

11. The color filter according to claim 9, wherein
the openings are arranged in parallel in the one direction and the other direction crossing to the one direction, and
a length between the openings adjacent to each other in the one direction is longer than a length between the openings adjacent to each other in the other direction.

12. The color filter according to claim 9, wherein
the openings are arranged in parallel in the one direction and the other direction crossing to the one direction,
the colored convex part is formed so as to have any one of:
at the central part of the colored layer in the one direction thereof, a straight line shape reaching both end parts in the other direction;
at the central part of the colored layer in the one direction thereof, a line shape along a peripheral edge part of the opening reaching both end parts in the other direction; and
at the central part of the colored layer in the one direction thereof, a bent line shape reaching a central part in the other direction from one end part in the other direction, and reaching the one end part in the other direction from the central part.

13. A liquid crystal display apparatus, comprising:
a liquid crystal layer formed using liquid crystal; and
a color filter configured to color light transmitted through the liquid crystal layer,
wherein the color filter is the color filter according to claim 9.

14. The liquid crystal display apparatus according to claim 13, further comprising
a blockage part configured to block light from being incident on the liquid crystal layer, or block light transmitted through the liquid crystal layer from being emitted,
wherein an arrangement position of the colored convex part of the color filter corresponds to an arrangement position of the blockage part.

15. A method of manufacturing a color filter, comprising:
a light shielding layer forming process of patterning a light shielding layer provided with a plurality of openings arranged in one direction thereof and a plurality of alignment marks on one surface of a transparent substrate, and
a colored layer forming process of patterning a colored layer which is disposed in each opening to close the opening, and is partially overlapped with the light shielding layer,
wherein, in the colored layer forming process, portions of the colored layer facing each other in the one direction thereof, which are to be respectively disposed in the two openings adjacent to each other in the one direction, are patterned by exposing using the same alignment mark to manufacture the color filter according to claim 9,
wherein the colored layer forming process includes:
a process of laminating a first colored material layer to form a colored layer of a first color on the transparent substrate bared through the light shielding layer and the opening;
a first exposing process of performing a first exposure on the first colored material layer corresponding to a part of a first colored layer including one side in the one direction thereof, which is to be disposed in a first opening, using one alignment mark;
a second exposing process of performing a second exposure on the first colored material layer corresponding to the residual part of the first colored layer, and again performing the exposure on the first colored material layer which is located at a central part of the portion to form the first colored layer in the one direction thereof, and on which the first exposure was performed;
a process of, after the first exposing process and the second exposing process end, forming the first colored layer;
a process of laminating a second colored material layer to form a colored layer of a second color different from the first color on the transparent substrate bared through the light shielding layer and the opening;
a third exposing process of performing a third exposure on the second colored material layer corresponding to a part of a second colored layer including the other side in the one direction thereof, which is to be disposed in a second opening adjacent to the one side in the one direction in the first opening, using the one alignment mark;
a fourth exposing process of performing a fourth exposure on the second colored material layer corresponding to the residual part of the second colored layer, and again performing the exposure on the second colored material layer which is located at the central part of the portion to form the second colored layer in the one direction thereof, and on which the third exposure was performed; and
a process of, after the third exposing process and the fourth exposing process end, forming the second colored layer.

16. The method of manufacturing a color filter according to claim 15, wherein
the light shielding layer forming process includes:
a process of laminating a light shielding material layer to form the light shielding layer on the one surface of the transparent substrate;
a fifth exposing process of performing a fifth exposure on the light shielding material layer corresponding to a part of the light shielding layer in the one direction thereof;
a sixth exposing process of performing a sixth exposure on the light shielding material layer corresponding to the other part adjacent to the part of the light shielding layer in the one direction thereof, and again performing the exposure at a position corresponding to the central part of the portion to form the opening in the one direction thereof, among the light shielding material layer on which the fifth exposure was performed; and
a process of, after the fifth exposing process and the sixth exposing process end, forming the light shielding layer.

17. The method of manufacturing a color filter according to claim 15, wherein
the light shielding layer has a light shielding convex part at a position corresponding to the central part in the one direction.

18. The method of manufacturing a color filter according to claim 17, wherein
the light shielding layer forming process includes:
a process of laminating a light shielding material layer to form the light shielding layer on the one surface of the transparent substrate;
a fifth exposing process of performing a fifth exposure on the light shielding material layer corresponding to a part of the light shielding layer in the one direction thereof;
a sixth exposing process of performing a sixth exposure on the light shielding material layer corresponding to the other part adjacent to the part of the light shielding layer in the one direction thereof, and again performing the exposure at a position corresponding to the central part of the portion to form the opening in the one direction thereof, among the light shielding material layer on which the fifth exposure was performed; and
a process of, after the fifth exposing process and the sixth exposing process end, forming the light shielding layer.
